(19) United States
(12) Patent Application Publication
(10) Pub. No.: US 2013/0010275 A1
(43) Pub. Date: Jan. 10, 2013

(54) LITHOGRAPHIC APPARATUS AND SPECTRAL PURITY FILTER

(75) Inventors: Viacheslav Medvedev, Moscow (RU); Vadim Yevgenyevich Banine, Deurne (NL); Vladimir Mihailovitch Krivtsun, Troitsk (RU); Wouter Anthon Soer, Nijmegen (NL); Andrei Mikhailovich Yakunin, Eindhoven (NL)

(73) Assignee: ASML Netherlands BV, Veldhoven (NL)

(21) Appl. No.: 13/634,179

(22) PCT Filed: Feb. 3, 2011
(86) PCT No.: PCT/EP11/51546

§ 371 Date: Sep. 11, 2012

Related U.S. Application Data
(60) Provisional application No. 61/317,167, filed on Mar. 24, 2010.
(60) Provisional application No. 61/330,721, filed on May 3, 2010.
(60) Provisional application No. 61/364,725, filed on Jul. 15, 2010.

(51) Int. Cl. G02B 5/28; G03B 27/72

(52) U.S. Cl. 355/71; 359/584; 359/359

(57) ABSTRACT

A reflector includes a multi layer mirror structure configured to reflect radiation at a first wavelength, and one or more additional layers. The absorbance and refractive index at a second wavelength of the multi layer mirror structure and the one or more additional layers, and the thickness of the multi layer mirror structure and the one or more additional layers, are configured such that radiation of the second wavelength which is reflected from a surface of the reflector interferes in a destructive manner with radiation of the second wavelength which is reflected from within the reflector.

### CROSS-REFERENCE TO RELATED APPLICATIONS

This application claims the benefit of U.S. provisional applications 61/317,167, 61/330,721 and 61/364,725, which were filed on Mar. 24, 2010, on May 3, 2010 and on Jul. 15, 2010, respectively, and which are incorporated herein in their entirety by reference.

### FIELD

The present invention relates to a lithographic apparatus and a reflector suitable for use therein.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

$$CD = {k}_{1} * \frac{λ}{NA} \qquad ( 1 )$$

where λ is the wavelength of the radiation used, NA is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA or by decreasing the value of k₁.

In order to shorten the exposure wavelength and, thus, reduce the minimum printable size, it has been proposed to use an extreme ultraviolet (EUV) radiation source. EUV radiation is electromagnetic radiation having a wavelength within the range of 5-20 nm, for example within the range of 13-14 nm, or example within the range of 5-10 nm such as 6.7 nm or 6.8 nm. Possible sources include, for example, laser-produced plasma sources, discharge plasma sources, or sources based on synchrotron radiation provided by an electron storage ring.

EUV radiation may be produced using a plasma. A radiation system for producing EUV radiation may include a laser for exciting a fuel to provide the plasma, and a source collector module for containing the plasma. The plasma may be created, for example, by directing a laser beam at a fuel, such as particles of a suitable material (e.g. tin), or a stream of a suitable gas or vapor, such as Xe gas or Li vapor. The resulting plasma emits output radiation, e.g., EUV radiation, which is collected using a radiation collector. The radiation collector may be a mirrored normal incidence radiation collector, which receives the radiation and focuses the radiation into a beam. The source collector module may include an enclosing structure or chamber arranged to provide a vacuum environment to support the plasma. Such a radiation system is typically termed a laser produced plasma (LPP) source.

Along with useful EUV in-band radiation, known LLP sources also produce non-useful, out-of-band radiation such as deep ultraviolet (DUV) and infrared (IR) as well as laser radiation scattered (reflected) from the plasma. IR radiation is electromagnetic radiation having a wavelength within the range of 0.1-500 μm, for example within the range of 5-15 μm. Out-of-band radiation, especially high power 10.6 μm radiation, produced by LPP sources may lead to unwanted heating of the patterning device, substrate and optics, reducing their lifetime. Known lithographic apparatus comprise optics which have a high reflectivity of the out-of-band radiation (for example at 10.6 μm) and hence the out-of-band radiation is able to reach the substrate with significant power. The presence of out-of-band radiation at the substrate may result in reduced imaging performance of the lithographic apparatus.

During the plasma creation process used to produce the beam of EUV radiation, the conversion of the fuel by the laser energy of the laser beam into plasma may be incomplete and hence fuel debris may be produced. The debris may come into contact with the radiation collector (which collects radiation output by the plasma within the source collector module) and may form a layer of debris on the surface of the radiation collector. The formation of a debris layer on the radiation collector may affect the optical properties of the radiation collector. For example, the formation of a debris layer, for instance a tin layer, on the radiation collector may increase the reflectivity of the radiation collector with respect to the out-of-band radiation. Hence, the out-of-band radiation may be able to reach the substrate with significant power. This may lead to a greater amount of out-of-band radiation being directed through the lithographic apparatus towards the substrate. A greater amount of out-of-band radiation being directed through the lithographic apparatus towards the substrate may lead to unwanted heating of the patterning device, substrate and optics, reducing their lifetime. The presence of out-of-band radiation at the substrate may also result in reduced imaging performance of the lithographic apparatus.

According to its abstract, WO 2010/022839 discloses a spectral purity filter configured to reflect EUV radiation. The spectral purity filter includes a substrate, and an antireflective coating on a top surface of the substrate. The anti-reflective coating is configured to transmit IR radiation. The filter also includes a multi-layer stack configured to reflect EUV radiation and to substantially transmit IR radiation.

### SUMMARY

It is desirable to provide a lithographic apparatus to obviate or mitigate one or more of the problems of the prior art, whether identified herein or elsewhere.

According to an aspect of the present invention, there is provided a reflector comprising a multi layer mirror structure configured to reflect radiation at a first wavelength, and one or more additional layers, the absorbance and refractive index at a second wavelength of the multi layer mirror structure and the one or more additional layers, and the thickness of the multi layer mirror structure and the one or more additional layers, being configured such that radiation of the second wavelength which is reflected from a surface of the reflector interferes in a destructive manner with radiation of the second wavelength which is reflected from within the reflector. The one or more additional layers may include a substrate which may be formed from silicon. The one or more additional layers may further include a metal layer located intermediate the substrate and the multi layer mirror structure. The metal layer may be formed from molybdenum. The one or more additional layers may further include an absorption layer located intermediate the substrate and the multi layer mirror structure, the absorption layer being configured to absorb radiation of the second wavelength. The absorption layer may include a material having optical properties substantially unaffected by temperature change. The absorption layer may be formed from one material selected from the group consisting of WO₃, TiO₂, ZnO, SiO₂, and SiC. The absorption layer may further be formed from a doped semiconductor. A layer of the one or more additional layers which lies adjacent the multi layer mirror structure may have a refractive index at the second wavelength which is different to that of the multi layer mirror structure at the second wavelength. The first wavelength may be an extreme ultraviolet wavelength and the second wavelength may be an infrared wavelength.

According to an aspect of the present invention, there is provided a lithographic apparatus having a source collector module configured to collect radiation, an illumination system configured to condition the radiation, and a projection system configured to project a beam of radiation formed from the radiation onto a substrate, wherein the source collector module, the illumination system, and/or the projection system comprises one or more reflectors according to aspects of the invention.

According to an aspect of the invention, there is provided a reflector comprising a multi layer mirror structure configured to reflect radiation at a first wavelength, and one or more additional layers, wherein the absorbance and refractive index at a second wavelength of the multi layer mirror structure and the one or more additional layers, and the thickness of the multi layer mirror structure and the one or more additional layers, are configured such that radiation of the second wavelength which is reflected from a surface of the reflector interferes in a destructive manner with radiation of the second wavelength which is reflected from within the reflector, when a layer of debris material is received by the multi layer mirror structure, the layer of debris material defining the surface of the reflector. The reflector may be configured such that the reflectivity of radiation of the second wavelength of the reflector is less than a predetermined threshold when there is no debris layer present on the reflector. The reflector may be configured such that the reflectivity of radiation of the second wavelength of the reflector is less than a predetermined threshold when a mono-layer of debris is present on the reflector.

In use, the thickness of the layer of debris material may increase over time, and the absorbance and refractive index at a second wavelength of the multi layer mirror structure and the one or more additional layers, and the thickness of the multi layer mirror structure and the one or more additional layers, may be configured such that, when a particular thickness of debris material layer is received by the multi layer mirror structure, radiation of the second wavelength which is reflected from the surface of the reflector interferes in a destructive manner with radiation of the second wavelength which is reflected from within the reflector. The reflector may be configured such that the reflectivity of radiation of the second wavelength of the reflector passes through a minimum reflectivity as the thickness of the debris layer increases, wherein the minimum reflectivity occurs when the debris layer has a particular thickness. The particular thickness of the debris layer may be equal to or greater than the thickness of a mono-layer of debris material.

According to an aspect of the invention, there is provided a reflector comprising a multi layer mirror structure configured to reflect radiation at a first wavelength, a substrate configured to absorb radiation at a second wavelength, and an anti reflection layer between the multi layer mirror structure and the substrate, the anti reflection layer being configured to promote the passage of radiation at the second wavelength from the multi layer mirror structure to the substrate, wherein the absorbance and refractive index at a second wavelength of the multi layer mirror structure and the anti reflection layer, and the thickness of the multi layer mirror structure and the anti reflection layer, are configured such that radiation of the second wavelength which is reflected from a surface of the reflector is less than that which is reflected from the multilayer mirror structure of the reflector without a layer of debris material, when a layer of debris material is received by the multi layer mirror structure, the layer of debris material defining the surface of the reflector.

In use, the thickness of the layer of debris material may increase over time, and the absorbance and refractive index at a second wavelength of the multi layer mirror structure and the one or more additional layers, and the thickness of the multi layer mirror structure and the one or more additional layers, may be configured such that, when a particular thickness of debris material layer is received by the multi layer mirror structure, radiation of the second wavelength which is reflected from the surface of the reflector interferes in a destructive manner with radiation of the second wavelength which is reflected from within the reflector. The reflector may be configured such that the reflectivity of radiation of the second wavelength of the reflector passes through a minimum reflectivity as the thickness of the debris layer increases, wherein the minimum reflectivity occurs when the debris layer has a particular thickness. The reflector may be configured such that the reflectivity of radiation of the second wavelength of the reflector is less than a predetermined threshold when there is no debris layer present on the reflector. The reflector may be configured such that the reflectivity of radiation of the second wavelength of the reflector is less than a predetermined threshold when a mono-layer of debris is present on the reflector. The particular thickness of the debris layer may be equal to or greater than the thickness of a mono-layer of debris material.

In use, the thickness of the layer of debris material may increase over time, and the reflector may be configured such that at least one characteristic of the reflector including the absorbance and refractive index at a second wavelength of the multi layer mirror structure, the absorbance and refractive index at a second wavelength of the one or more additional layers, the thickness of the multi layer mirror structure, and the thickness of one or more additional layers, may be actively changed over time as a function of the thickness of debris layer, such that radiation of the second wavelength which is reflected from the surface of the reflector interferes in a destructive manner with radiation of the second wavelength which is reflected from within the reflector. The reflector may be configured such that the temperature of the reflector may be actively changed, thereby actively changing the at least one characteristic of the reflector. The change in the at least one characteristic of the reflector may arise from a change in the charge carrier concentration within at least one of the multi layer mirror structure and the one or more additional layers.

According to yet another aspect, there is provided a spectral purity filter configured to reflect extreme ultraviolet radiation, the spectral purity filter including a substrate, an anti-reflection coating on a top surface of the substrate, the anti-reflection coating being configured to transmit infrared radiation and a multi-layer stack configured to reflect extreme ultraviolet radiation and to substantially transmit infrared radiation, the multi-layer stack comprising alternating layers of silicon (Si) and diamond-like carbon (DLC), wherein the Si is doped Si and/or the diamond-like carbon is doped diamond-like carbon. The doping may have an impurity concentration of between 5×10¹⁸ cm⁻³ and 5×10¹⁹ cm⁻³, preferably between 8×10¹⁸ cm⁻³ and 2×10¹⁹ cm⁻³. Typically, about 1×10¹⁹ cm⁻³ is a suitable impurity concentration.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a more detailed view of the apparatus of FIG. 1, including a laser produced plasma (LPP) source collector module;

FIG. 3 depicts a schematic cross section through a prior art spectral purity filter;

FIG. 4 depicts a schematic cross section through a reflector in accordance with an embodiment of the present invention;

FIG. 5 depicts a plot showing the optical response of the reflector shown in FIG. 4;

FIG. 6 depicts a schematic cross section through a reflector in accordance with an embodiment of the present invention;

FIG. 7 depicts a plot showing the optical response of the reflector shown in FIG. 6;

FIG. 8 depicts a schematic cross section through a reflector in accordance with an embodiment of the present invention;

FIG. 9 depicts a plot showing the optical response of the reflector shown in FIG. 8;

FIG. 10 depicts a schematic cross section through a reflector in accordance with an embodiment of the present invention;

FIG. 11 depicts a plot showing the optical response of the reflector shown in FIG. 10;

FIG. 12 depicts a plot showing the optical response of a reflector in accordance with an embodiment of the present invention;

FIG. 13 depicts a plot showing the optical response of the reflector shown in FIG. 12 compared to the response of two other embodiments of the present invention;

FIG. 14 depicts a plot showing the reflectivity of out-of-band radiation of a reflector according to an embodiment of the present invention which is not optimized for the presence of a debris layer;

FIG. 15 depicts a plot showing the minimum reflectivity of out-of-band radiation of a reflector according to an embodiment of the invention as a function of charge carrier concentration;

FIG. 16 depicts a plot showing the relationship between the number of periods in a multi-layer mirror (MLM) structure of a reflector and the concentration of charge carriers;

FIG. 17 depicts a plot showing the reflectivity for out-of-band radiation of a reflector according to an embodiment of the invention;

FIG. 18 depicts a plot showing the reflectance of out-of-band radiation of a reflector according to an embodiment of the invention;

FIG. 19 depicts a schematic cross section through a reflector in accordance with an embodiment of the invention;

FIG. 20 depicts a plot showing reflectance of out-of-band radiation of two reflectors according to embodiments of the invention;

FIG. 21 depicts a schematic cross section through another reflector;

FIG. 22 depicts a plot showing the relationship between the n-type dopant concentration and the refractive index of Si; and

FIG. 23 depicts a schematic cross section through yet another reflector.

### DETAILED DESCRIPTION

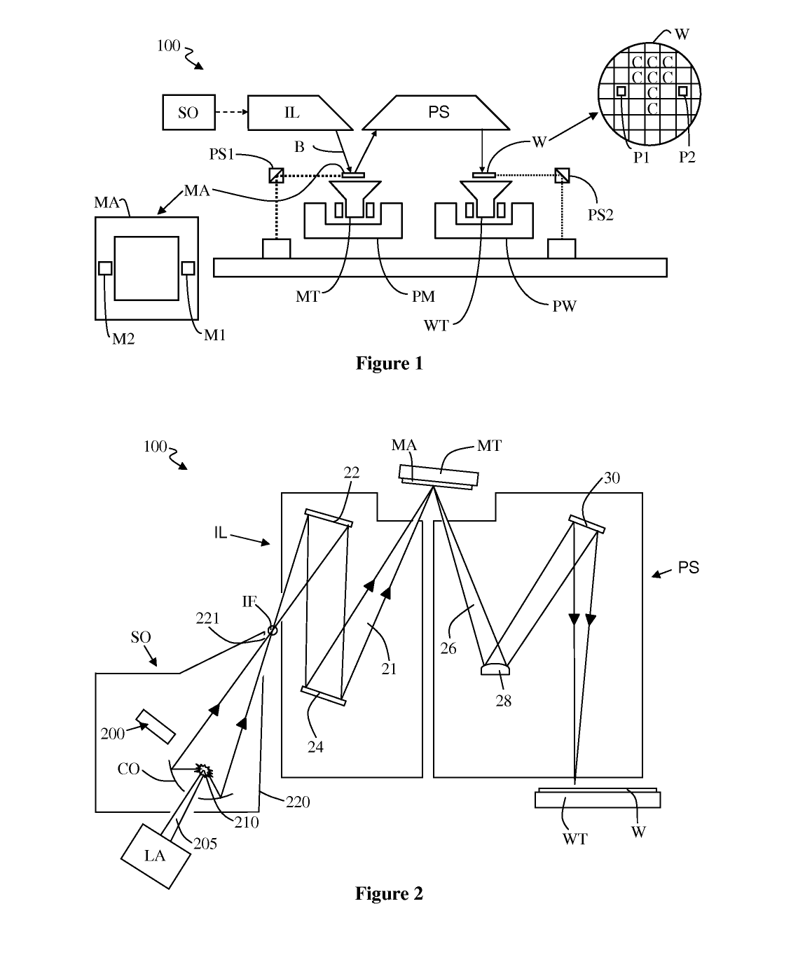

FIG. 1 schematically depicts a lithographic apparatus 100 including a source collector module SO according to one embodiment of the invention. The apparatus comprises: an illumination system (illuminator) IL configured to condition a radiation beam B (e.g. EUV radiation); a support structure (e.g. a mask table) MT constructed to support a patterning device (e.g. a mask or a reticle) MA and connected to a first positioner PM configured to accurately position the patterning device; a substrate table (e.g. a substrate table) WT constructed to hold a substrate (e.g. a resist-coated substrate) W and connected to a second positioner PW configured to accurately position the substrate; and a projection system (e.g. a reflective projection system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The projection system, like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since gases may absorb EUV radiation. A vacuum environment may therefore be provided to the whole beam path with the aid of a vacuum wall and vacuum pumps.

As here depicted, the apparatus is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultra violet (EUV) radiation beam from the source collector module SO. EUV radiation is electromagnetic radiation having a wavelength within the range of 5-20 nm, for example within the range of 13-14 nm, or example within the range of 5-10 nm such as 6.7 nm or 6.8 nm. Methods to produce EUV radiation include, but are not necessarily limited to, converting a material into a plasma state that has at least one element, e.g., xenon, lithium or tin, with one or more emission lines in the EUV range. In one such method, often termed laser produced plasma (“LPP”) the required plasma can be produced by irradiating a fuel, such as a droplet, stream or cluster of material having the required line-emitting element, with a laser beam. The source collector module SO may be part of an EUV radiation system including a laser, not shown in FIG. 1, for providing the laser beam exciting the fuel. The resulting plasma emits output radiation, e.g. EUV radiation, which is collected using a radiation collector, disposed in the source collector module.

The laser and the source collector module may be separate entities, for example when a CO₂ laser is used to provide the laser beam for fuel excitation. In such cases, the laser is not considered to form part of the lithographic apparatus and the radiation beam is passed from the laser to the source collector module with the aid of a beam delivery system comprising, for example, suitable directing mirrors and/or a beam expander. In other cases the source may be an integral part of the source collector module, for example when the source is a discharge produced plasma EUV generator, often termed as a DPP source.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as facetted field and pupil mirror devices. The illuminator may be used to condition the radiation beam, to have a desired uniformity and intensity distribution in its cross-section.

The radiation beam B is incident on the patterning device (e.g. mask) MA, which is held on the support structure (e.g. mask table) MT, and is patterned by the patterning device. After being reflected from the patterning device (e.g. mask) MA, the radiation beam B passes through the projection system PS, which focuses the beam onto a target portion C of the substrate W. With the aid of the second positioner PW and position sensor PS2 (e.g. an interferometric device, linear encoder or capacitive sensor), the substrate table WT can be moved accurately, e.g. so as to position different target portions C in the path of the radiation beam B. Similarly, the first positioner PM and another position sensor PS1 can be used to accurately position the patterning device (e.g. mask) MA with respect to the path of the radiation beam B. Patterning device (e.g. mask) MA and substrate W may be aligned using mask alignment marks M1, M2 and substrate alignment marks P1, P2.

The depicted apparatus could be used in at least one of the following modes:

1. In step mode, the support structure (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.
2. In scan mode, the support structure (e.g. mask table) MT and the substrate table WT are scanned synchronously while a pattern imparted to the radiation beam is projected onto a target portion C (i.e. a single dynamic exposure). The velocity and direction of the substrate table WT relative to the support structure (e.g. mask table) MT may be determined by the (de-)magnification and image reversal characteristics of the projection system PS.
3. In another mode, the support structure (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2 shows the apparatus 100 in more detail, including the source collector module SO, the illumination system IL, and the projection system PS. The source collector module SO is constructed and arranged such that a vacuum environment can be maintained in an enclosing structure 220 of the source collector module SO.

A laser LA is arranged to deposit laser energy via a laser beam 205 into a fuel, such as xenon (Xe), tin (Sn) or lithium (Li) which is provided from a fuel supply 200, thereby creating a highly ionized plasma 210 with electron temperatures of several 10's of eV. The energetic radiation generated during de-excitation and recombination of these ions is emitted from the plasma, collected and focused by a near normal incidence collector optic CO. Such a source collector module SO is typically termed a laser produced plasma (LPP) source. The collected radiation may comprise not only useful, in-band radiation (for example EUV radiation), but also non-useful, out-of-band radiation (for example DUV or IR radiation). The useful, in-band radiation may be used to apply a desired pattern to the substrate, whereas the non-useful, out-of-band radiation may not.

The deposition of laser energy via the laser beam 205 into the fuel may produce debris from the fuel which may come in to contact with the collector optic CO (also referred to as the collector) and may form a layer of debris on the surface of the collector CO. The formation of a debris layer on the radiation collector may affect the optical properties of the collector CO. For example, the formation of a debris layer, for instance a tin layer, on the collector CO may increase the amount of out-of-band radiation which is reflected by of the collector CO.

Radiation that is reflected by the collector optic CO is focused in a virtual source point IF. The virtual source point IF is commonly referred to as the intermediate focus, and the source collector module SO is arranged such that the intermediate focus IF is located at or near an opening 221 in the enclosing structure 220. The virtual source point IF is an image of the radiation emitting plasma 210.

Subsequently the radiation traverses the illumination system IL, which may include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the substrate stage or substrate table WT.

More elements than shown may generally be present in the illumination system IL and projection system PS. Further, there may be more minors present than those shown in the Figures, for example there may be 1-6 additional reflective elements present in the projection system PS than shown in FIG. 2.

The non-useful out-of-band radiation produced by LPP sources may lead to unwanted heating of the patterning device and optics, reducing their lifetime and/or reducing the accuracy with which patterns are projected on to the substrate.

The mirror devices 22, 24, reflective elements 28, 30, collector optic CO and other optical components of the source collector module, illumination system and/or projection system of some known lithographic apparatus may comprise reflectors having a multilayer mirror (MLM) structure. The MLM structure may have a plurality of alternating relatively high refractive index layers and relatively low refractive index layers. The relatively low refractive index layers are substantially non-absorbent of radiation at the wavelength the MLM is configured to reflect. The reflector may also comprise a substrate layer onto which the plurality of alternating layers of the MLM structure are deposited. Known materials for the relatively high refractive index layers and the relatively low refractive index layers are molybdenum (Mo) and silicon (Si) respectively, where the wavelength of radiation to be reflected is in the EUV range.

It is common to refer to the alternating layers of an MLM structure as being periodic, whereby one period consists of a plurality of layers which are the unit of repetition of the alternating structure. In the case above a period consists of a high refractive index Mo layer and relatively low refractive index Si layer. The thickness of one period is generally chosen to be approximately half the wavelength of radiation to be reflected. In this manner, constructive interference between scattered radiation from each relatively high refractive index layer causes the MLM to reflect radiation of the desired wavelength.

Such multilayer mirror structures are not only good reflectors of the useful, in-band radiation, but also good reflectors of the non-useful, out-of-band radiation (such as IR radiation, for example at 10.6 μm). The high reflectivity of these multilayer mirrors at the wavelength of the out-of-band radiation is due to the relatively high reflectivity (relatively low absorbance and transmission) of molybdenum at the wavelength of the out-of-band radiation. Since the MLM structures are good reflectors of out-of-band radiation, it follows that the out-of-band radiation is able to reach the substrate with significant power. The presence of out-of-band radiation at the substrate may result in reduced imaging performance of the lithographic apparatus. One reason for this is that the heating of the substrate due to the out-of-band radiation incident on it may cause thermal expansion of the substrate.

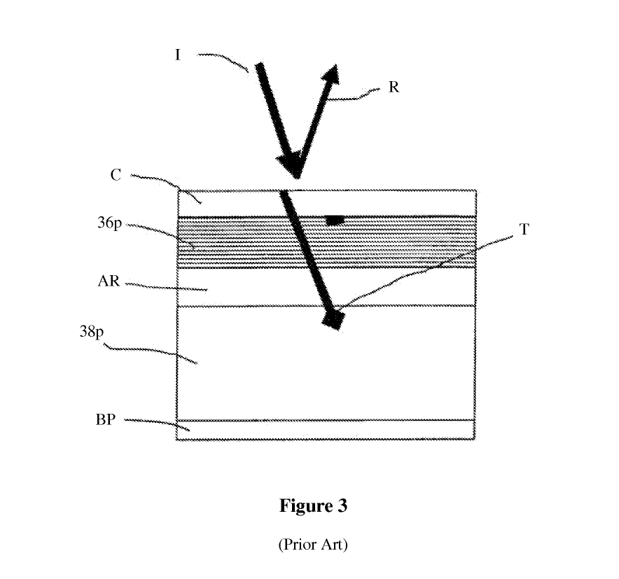

A known spectral purity filter described in WO 2010/022839 is shown in FIG. 3. The spectral purity filter comprises a substrate 38p having a backing plate BP. The spectral purity filter also comprises a multi layer mirror structure 36p having alternating mirror layers. An anti-reflection coating AR is provided between the substrate 38p and multi layer mirror structure 36p. The spectral purity filter additionally comprises a capping layer C on top of the multi layer mirror structure 36p. The spectral purity filter functions as follows: Radiation (indicated by I) is incident on the spectral purity filter. The incident radiation I contains both useful EUV radiation and non-useful IR radiation. Both the EUV radiation and IR radiation pass through the capping layer C. The alternating mirror layers within the multi layer mirror structure are configured such that they are transparent to IR radiation, while at the same time being reflective to EUV radiation. Consequently, EUV radiation is reflected (indicated by R) by the multi layer mirror structure 36p of the spectral purity filter, while IR radiation is allowed to pass to the anti-reflection coating AR. The thickness and material of the anti-reflection coating AR are chosen such that very little IR radiation is reflected by the interface between the anti-reflection coating AR and the multi layer mirror structure 36p. Instead, the IR radiation is transmitted into the anti-reflection coating AR. The anti-reflection coating AR is transparent to the IR radiation and therefore the IR radiation passes through the anti-reflection coating AR and into the substrate 38p (this is indicated by T). The material of the substrate is chosen such that it is a good absorber of IR radiation. Consequently, the substrate 38p absorbs the IR radiation. The backing plate BP may be made of a material of high thermal conductivity so that heating of the substrate 38p due to the absorption of the IR radiation can be dissipated.

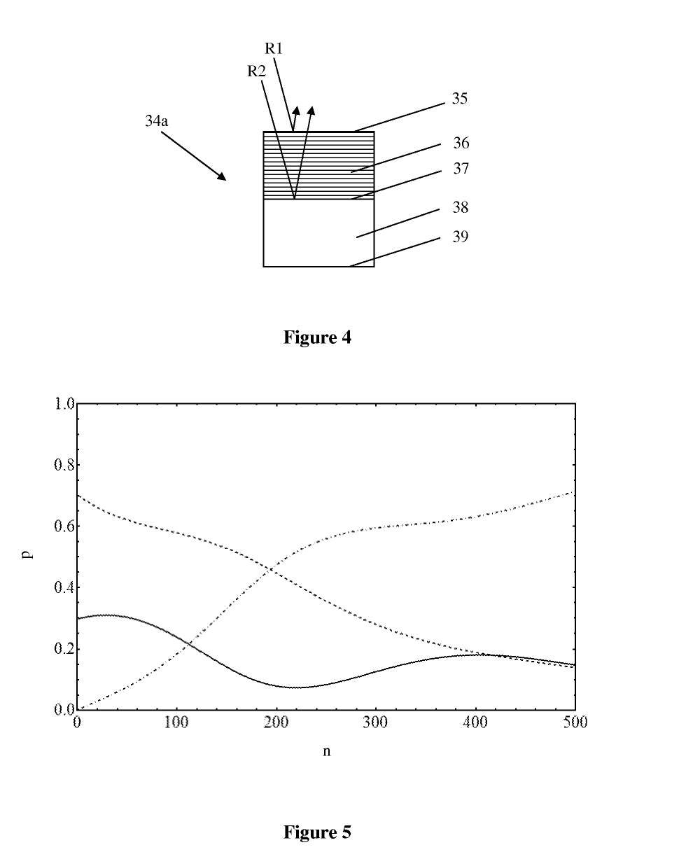

A reflector 34a in accordance with an embodiment of the invention is shown in FIG. 4. The reflector 34a comprises a multi layer mirror structure 36 comprising alternating layers (also known as alternating mirror layers) of diamond-like carbon (DLC) and n-type silicon (n-Si). The reflector further comprises an additional layer, which in this case is a Si substrate 38. The multi layer mirror structure 36 is provided on the Si substrate 38.

The multi layer mirror structure 36 of all embodiments of the present invention acts as a Bragg reflector for in-band radiation. The thickness of the individual layers of the multi layer mirror structure of the present invention is small when compared to the wavelength of the out-of-band radiation. For this reason the multi layer mirror structure of the present invention can be considered to have an ‘average’ or bulk refractive index for the out-of-band radiation. Furthermore, because the multi layer mirror structure may be considered to have a bulk refractive index for the out-of-band radiation, the interfaces between each of the layers of the multi layer mirror structure substantially do not reflect any out-of-band radiation.

It will be appreciated that any appropriate materials may be used in place of DLC and n-Si, provided they can cause substantial reflection of the in-band radiation and providing they are absorbent of out-of-band radiation. Such a MLM structure will absorb some of the out-of-band radiation while reflecting much of the in-band radiation. Consequently, the amount of out-of-band radiation which propagates through the lithographic apparatus to the substrate via any such reflector is reduced.

The materials which form part of the reflector 34a may be chosen such that they are capable of withstanding heat generated by absorption of the out-of-band radiation without causing degradation of the reflector 34a. In addition, a reflector according to any embodiment of the present invention may be provided a heat dissipater for dissipating heat due to the absorption of the out-of-band radiation. The heat dissipater may comprise a heat sink or a coolant system. The coolant system may be a water coolant system.

In this embodiment of the invention, the Mo layers of prior art MLMs have been replaced with another material (in this case DLC) having good reflection of useful in-band radiation (for example EUV radiation) and substantial absorption at the wavelength of out-of-band radiation (for example IR radiation). The reflector 34a differs from the alternating mirror layers of the prior art shown in FIG. 3, in which the alternating layers are substantially transparent to IR radiation such that it will reach the anti-reflection coating and be transmitted in to the substrate where it can be absorbed.

FIG. 5 shows the optical response of the reflector shown in FIG. 4, as a function of the number of periods of the MLM structure 36 (axis labelled n within the figure). The DLC layers have a thickness of 2.8 nm and the n-Si layers have a thickness of 4.1 nm. The concentration of charge carriers within the MLM structure 36 is approximately 3×10¹⁹ cm⁻³. The optical response is shown for radiation having a wavelength of 10.6 μm. Within FIG. 5, the solid line shows the proportion of incident radiation which is reflected, the dashed line shows the proportion of the radiation which is transmitted, and the dot-dashed line shows the proportion of radiation which is absorbed. It can be seen from FIG. 5 that the minimum reflection of about 7% occurs at a number of periods which is about 220. Within the Figure, the axis labelled p is the proportion of incident radiation.

The use within the MLM structure of a material with an increased absorbance of out-of-band radiation causes the reflectivity of the MLM with respect to out-of-band radiation to reduce. This is because absorbance (A), reflectance (R) and transmittance (T) of the MLM are related by the energy balance equation:

A+R+T=1 (2)

The local absorption efficiency (A_{E}) of a material, for example a material out of which part of an MLM structure is fabricated, at a point (r) is defined by:

$${A}_{E} = Im [ ɛ ( ω ) ] \frac{{E ( r )}^{2}}{4 π} \qquad ( 3 )$$

where ε(ω) is permittivity of the material and E(r) is the electric field at point r. It follows that in order to increase absorption rate at a particular point r with given ε, the electric field E(r) of the material should be increased. The electric field within the MLM can be changed, for example, by changing the material from which the MLM structure is constructed.

One way of changing the material from which the MLM structure is constructed is by the doping of any of the layers and/or the substrate. An example of a class of doped materials is doped semiconductors. Doped semiconductors, such as doped silicon or doped carbon (e.g. doped DLC), are good absorbers of IR radiation. By altering the doping of a semiconductor it is possible to alter concentration of charge carriers within the semiconductor and hence the refractive index and absorbance of the semiconductor. For example, increasing the dopant level within a semiconductor may increase the concentration of charge carriers and hence the refractive index and absorbance of the semiconductor.

Referring again to FIG. 5, it will be appreciated that the reflectivity of the reflector relating to IR radiation (at 10.6 μm) decreases to a minimum at approximately 220 periods and then increases as the number of periods increases. The out-of-band (IR) radiation is reflected from any interface between two materials of different refractive index. The thickness of each of the alternating layers within the MLM structure 36 is very small when compared to the wavelength of the IR radiation and therefore the MLM structure 36 can be considered to have a single ‘average’ refractive index with respect to the IR radiation. It follows that there are three refractive index interfaces in the embodiment of the invention shown in FIG. 4: a first interface 35 (also referred to as the radiation receiving surface of the reflector) between the exterior of the reflector 34a and the MLM structure 36, a second interface 37 between the MLM structure 36 and the substrate 38; and a third interface 39 (also referred to as the rear surface of the reflector) between the substrate 38 and the exterior of the reflector 34a.

Minimum reflection from the reflector is achieved when the sum of the reflected waves from each interface is a minimum. Because the alternating layers 36 and substrate absorb some of the out-of-band radiation and because the first and second interfaces 35 and 37 reflect much of the out-of-band radiation, the reflection from the third interface 39 is comparatively small and therefore need not be considered. It will be appreciated that in some embodiments of the invention, the reflection from the third interface 39 may be comparable to the reflection from the first and second interfaces 35 and 37. Should this be the case, the reflection from the third interface would also have to be considered. When considering just the first and second interfaces 35 and 37, the minimum reflection will occur when the sum of the reflection from the first and second interfaces 35 and 37 at the radiation receiving surface 35 is a minimum. In some cases, the sum of the reflection from the first and second interfaces 35 and 37 will have a minimum of zero. The sum of the reflection from the first and second interfaces 35 and 37 will equal zero at the radiation receiving surface 35 when an incident wave of out-of-band radiation (indicated by R2) which has travelled through the MLM structure 36, has been reflected at interface 37 and has travelled back to the interface 35 via the MLM structure 36 has the same amplitude as, and is in anti-phase with, the out-of-band radiation (indicated by R1) which has reflected at interface 35. This may be referred to as total destructive interference between waves R1 and R2.

Although the waves of out-of-band radiation reflected from each refractive index interface of the reflector may sum to zero at the radiation receiving surface 35 (referred to as total destructive interference), this may not always be the case. It is within the scope of the present invention that the waves of out-of-band radiation reflected from each refractive index interface sum at the radiation receiving surface to produce a total reflected wave of out-of-band radiation from the reflector which has a substantially smaller amplitude compared to that of the MLM structure of the reflector in isolation (i.e. without any additional layer(s)). Such a substantially smaller amplitude of the total reflected wave of out-of-band radiation from a reflector according to an embodiment of the invention may be less than 50% of the total reflected wave of out-of-band radiation of the MLM structure in isolation, may be less than 25%, may be less than 10%, may be less than 5% and may be less than 1%. This is referred to as the out-of-band radiation reflected from the radiation receiving surface interfering in a destructive manner with the out-of-band radiation which is reflected from within the reflector structure. This may also be called destructive interference of the out-of-band radiation.

In order to achieve destructive interference (of the out-of-band radiation) at the radiation receiving surface 35, several factors may be taken into consideration: the refractive indices with respect to the out-of-band radiation of the alternating layers of the MLM structure 36, the substrate 38 and the environment to the exterior of the reflector 34a (usually a vacuum); the absorbance with respect to the out-of-band radiation of the alternating layers of the MLM structure 36 (and depending on the embodiment, the absorbance of the substrate 38); and the total thickness of the MLM structure 36 (and depending on the embodiment, the thickness of the substrate 38).

By altering the refractive indices it is possible to alter the amount of reflection that occurs at each interface. This is because the amount of reflection that occurs at an interface is dependant on the refractive index of the material on either side of the interface. These relationships are described, for example, by the Fresnel equations which are well known to the person skilled in the art. Altering the amount of reflection which occurs at each interface will affect the amplitude of both waves R1 and R2. As discussed above, the refractive index of the alternating layers of the MLM structure 36 and/or that of the substrate may be altered by doping the materials from which they are made and by altering the amount of the dopant used (and hence the charge carrier concentration). It is also possible to alter the refractive index of the alternating layers of the MLM structure 36 or that of the substrate 38 by making them from a different material.

Altering the refractive index of a material affects the speed at which radiation travels through the material. The speed at which radiation travels through a material is inversely proportional to the refractive index of the material. The optical path length of a wave of radiation through a medium is given by the product of the geometric length of the path the radiation follows through a medium and the index of refraction of the medium. Increasing (or decreasing) the refractive index of the alternating layers of the MLM structure 36 will cause the optical path length of wave R2 of out-of band radiation through the MLM structure 36 to increase (or decrease). As a consequence of altering the optical path length of wave R2 through the MLM structure 36, altering the refractive index of the alternating layers of the MLM structure will alter the optical path difference (and hence phase difference) between waves R1 and R2 once they have been reflected by the reflector 34a.

By altering the absorbance of the alternating layers of the MLM structure 36 (and depending on the embodiment, the absorbance of the substrate 38) it is possible to alter the amplitude of the wave R2. The greater the absorbance of the alternating layers, the less the amplitude of the wave R2 will be once it has been reflected by the reflector 34a. As discussed above, the absorbance of the alternating layers of the MLM structure 36 may be altered by doping the materials from which they are made and by altering the amount of the dopant used (and hence the charge carrier concentration). It is also possible to alter the absorbance of the alternating layers of the MLM structure 36 by making them from a different material.

Altering the total thickness of the MLM structure 36 will alter both the amplitude of the wave R2 that is reflected by reflector 34a and also the phase difference between waves R1 and R2 once they have been reflected by the reflector 34a. This is because increasing (or decreasing) the total thickness of the MLM structure 36 will increase (or decrease) the optical path length of R2 through the MLM structure 36. By altering the optical path length of wave R2 through the MLM structure 36, the optical path difference between waves R1 and R2 will be altered, hence altering the phase difference between waves R1 and R2 once they have been reflected by the reflector 34a. The amplitude of wave R2 that is reflected by the MLM structure 34a will also be affected by altering the distance wave R2 has to travel through the MLM structure 36. This is because the alternating layers of the MLM structure 36, being an absorber of the out-of-band radiation, absorb a greater proportion of wave R2 the further the wave R2 has to travel through it.

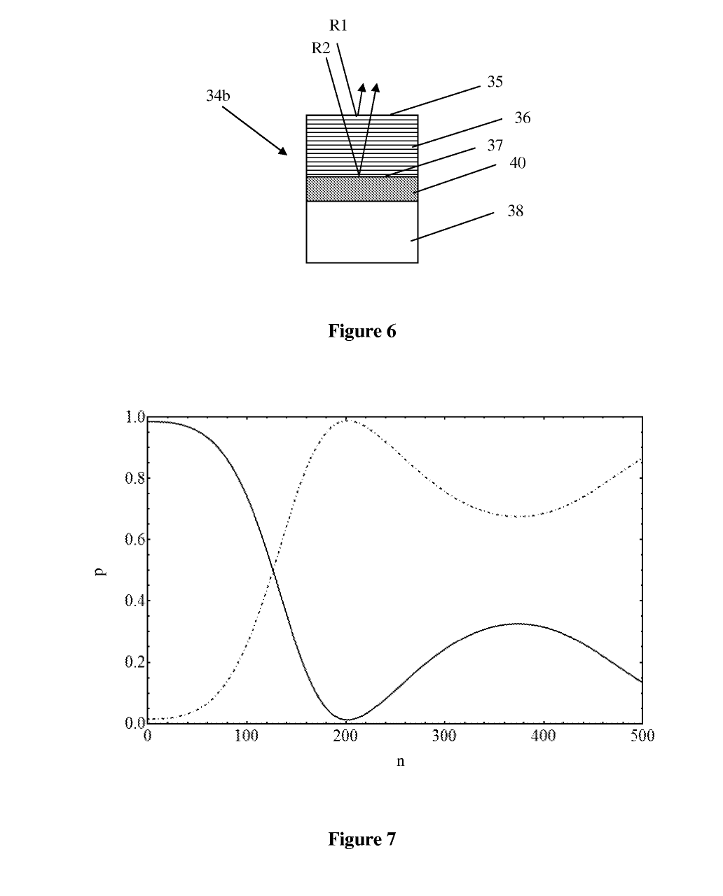

A reflector 34b according to an embodiment of the present invention is shown in FIG. 6. The reflector 34b comprises an MLM structure 36 having alternating layers of DLC and n-type silicon (n-Si). The reflector 34b further comprises additional layers. The MLM structure 36 is provided on the additional layers. The additional layers are a Si substrate 38 and a metal layer 40 sandwiched between the substrate 38 and MLM structure 36. In the shown embodiment, the metal layer 40 is a Mo layer with a thickness of 100 nm.

FIG. 7 shows the optical response of the reflector 34b shown in FIG. 6, as a function of the number of periods of the alternating layers of the MLM structure 36 (axis labelled n within the figure). The DLC layers have a thickness of 2.8 nm and the n-Si layers have a thickness of 4.1 nm. The concentration of charge carriers within the alternating layers of the MLM structure 36 is approximately 3×10¹⁹ cm⁻³. The optical response is shown for radiation having a wavelength of 10.6 μm. Within FIG. 7, the solid line shows the proportion of incident radiation which is reflected and the dot-dashed line shows the proportion of radiation which is absorbed. Within the Figure, the axis labelled p is the proportion of incident radiation. It can be seen from FIG. 7 that the minimum reflection of about 1% occurs at a number of periods which is about 200. It is thought that the minimum reflectance of this embodiment is much less than that of the prior art shown in FIG. 3 because the metal layer substantially prevents any out-of-band radiation from being transmitted through the metal layer. Substantially preventing any out-of-band radiation from being transmitted through the metal layer means that metal layer may absorb out-of-band radiation and reflect the out-of-band radiation such that it can be absorbed by the MLM structure and/or destructively interfere with out-of-band radiation incident on the reflector.

As mentioned above, the metal layer 40 substantially prevents any transmission of the out-of band radiation (through the metal layer 40). This means that the majority of the wave R2 of incident out-of-band radiation which reaches the interface between the metal layer 40 and alternating layers 36 will be reflected or absorbed by the metal layer 40. In the embodiment shown, the metal layer is 100 nm thick Mo. It will be appreciated that any metal which is substantially reflective at the wavelength of the out-of-band radiation may be used. In order for the metal layer 40 to be capable of substantially reflecting the out-of-band radiation, the thickness of the metal layer should be greater than the skin depth of the metal at the wavelength of the out-of band radiation.

In some embodiments of the invention, it may be desirable to use a metal for the metal layer which is both substantially reflective at the wavelength of the out-of-band radiation and also has a high thermal conductivity, for example copper. The high thermal conductivity of the metal layer may be advantageous because it may to enable the metal layer to dissipate heat created in the reflector 34b resulting from the absorption of the out-of-band radiation.

Referring again to FIG. 7, it can be seen that substantially no out-of-band IR radiation is transmitted through the reflector 34b. It can also be seen that the reflection of the out-of band radiation decreases, as the number of periods (i.e. the total thickness) of the MLM structure 36 decreases, to a minimum at about 200 periods. The reflection of the out-of-band radiation then increases as the total thickness of the MLM structure 36 increases. As with the previous embodiment, the minimum reflection of the out-of band radiation will occur when the reflected waves from all the refractive index interfaces sum to a minimum at the radiation receiving surface 35. In the present embodiment, the only refractive index interfaces which need to be considered are the first interface 35 between the exterior of the reflector 34b and the MLM structure 36, and a second interface 37 between the MLM structure 36 and the metal layer 40. It is not necessary to consider the interfaces between the metal layer 40 and the substrate 38; and between the substrate 38 and the exterior of reflector 34b, because the metal layer 40 substantially prevents any of the out-of-band radiation from reaching these interfaces. As with the previous embodiment, when considering just the first and second interfaces 35 and 37, the minimum reflection will occur when the sum of the reflection from the first and second interfaces 35 and 37 is a minimum at the radiation receiving surface 35. In some cases, the sum of the reflection from the first and second interfaces 35 and 37 may be zero. In this condition, the reflected waves are said to exhibit total destructive interference. The sum of the reflection from the first and second interfaces 35 and 37 will equal zero at the radiation receiving surface 35 when the wave of out-of-band radiation (indicated by R2) which has travelled through the MLM structure 36, has been reflected at interface 37 and has travelled back to the interface 35 via the MLM structure 36 has the same amplitude as, and is in anti-phase with, the wave of out-band-radiation (indicated by R1) which has reflected at interface 35.

In order to achieve the minimum sum of the reflection from the first and second interfaces 35 and 37 at the radiation receiving surface 35, several factors are taken into consideration: the refractive index of the alternating layers 36 of the MLM with respect to the out-of-band radiation, the refractive index of the environment to the exterior of the reflector 34b (usually a vacuum); the absorbance with respect to the out-of-band radiation of the alternating layers of the MLM structure 36 and the reflectance with respect to the out-of-band radiation of the metal layer 38; and the total thickness of the alternating layers of the MLM structure 36.

The refractive index and absorbance of the alternating layers can be altered in the same manner as discussed above. Altering the refractive index, absorbance and total thickness of the alternating layers of the MLM structure 36 has the same effect that was described in relation to the embodiment above. By changing the metal from which the metal layer 40 is made, for example, it is possible to alter the reflectance of the metal layer 40 with respect to the out-of-band radiation. Altering the reflectance of the metal layer 40 will govern the amplitude of wave R2 when it has been reflected by the reflector 34b. This is because, the greater the reflectance of the metal layer 40, the greater the proportion of the wave R2 will be reflected by the metal layer 40 towards the first interface 35, as opposed to being absorbed by the metal layer.

The embodiments of the present invention discussed above both use in excess of 200 periods of the alternating layers of the MLM structure 36 so as to achieve the minimum reflectance. It is thought that these embodiments use a large number of layers in the MLM structure because the reflectance at the interface 37 is relatively high. This means that, due to the absorbance characteristics of the MLM structure, a substantial total thickness of the MLM structure 36 is desired so as to attenuate the amplitude of the wave R2 so that it is substantially equal in amplitude to the amplitude of wave R1 once they have both been reflected by the reflector. In some embodiments of the present invention, it may not be desirable to provide the MLM structure with so many periods of the alternating layers. For example, possible methods used to apply the alternating layers include vacuum deposition whereby the deposited particles are created using thermal evaporation, sputtering cathode arc vaporization, laser ablation or the decomposition of a chemical vapor precursor. Such methods may be costly and time consuming, the cost and production time increasing with increasing number of alternating layers. In this situation it may be advantageous to be able to provide an effective MLM structure which comprises fewer periods of the alternating layers so as to reduce cost and reduce MLM production time.

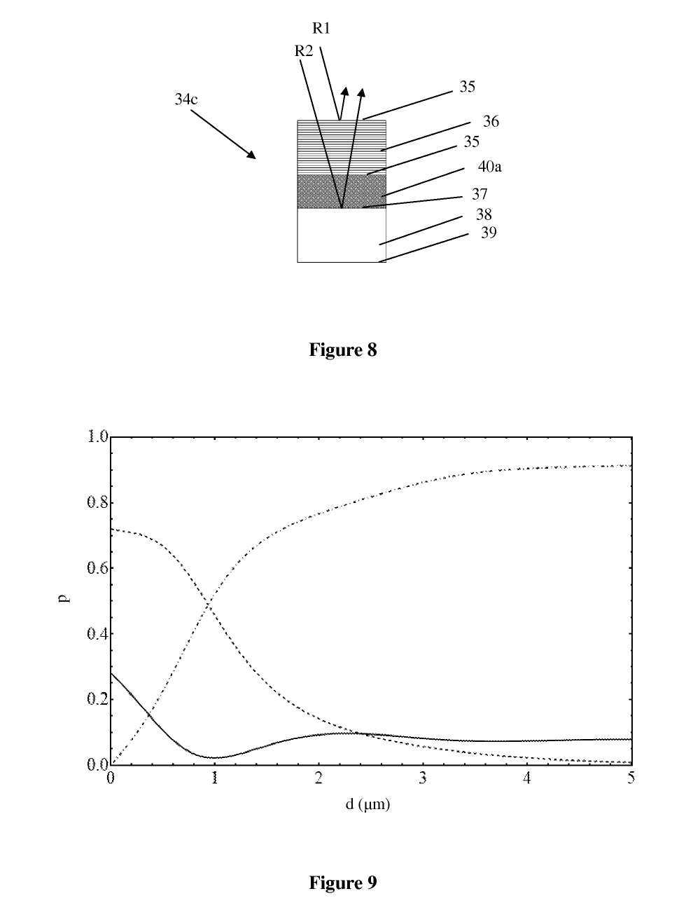

A reflector 34c according to an embodiment of the present invention is shown in FIG. 8. The reflector 34c comprises a MLM structure 36, comprising alternating layers of DLC and n-type silicon (n-Si). The reflector 34c further comprises additional layers. The MLM structure is provided on the additional layers. The additional layers are a Si substrate 38 and an absorption layer 40a sandwiched between the substrate 38 and the MLM structure 36. In the shown embodiment, the absorption layer 40a is an n-Si layer. However, any suitable material may be used for the absorption layer 40a provided it is capable of substantially absorbing out-of-band radiation. Another example of a suitable material for the absorption layer 40a is p-type silicon (p-Si).

FIG. 9 shows the optical response of a reflector according to that shown in FIG. 8 as a function of the thickness of the absorption layer 40a (this is indicated by the axis d within the figure). The DLC layers have a thickness of 2.8 nm and the n-Si layers have a thickness of 4.1 nm. There are 40 periods of the alternating layers of the MLM structure 36. The concentration of charge carriers within the alternating layers of the MLM structure 36 is approximately 3×10¹⁹ cm⁻³. The optical response is shown for radiation having a wavelength of 10.6 μm. Within FIG. 9, the solid line shows the proportion of incident radiation which is reflected, the dashed line shows the proportion of the radiation which is transmitted, and the dot-dashed line shows the proportion of radiation which is absorbed. Within the Figure, the axis labelled p is the proportion of incident radiation. It can be seen from the graph that the minimum reflection of about 5% occurs at an absorption layer thickness of about 1 μm. It is thought that the minimum reflectance of this embodiment is much less than that of the embodiment shown in FIG. 4 because the absorption layer 40a (which is n-Si in this case) increases the proportion of the incident radiation which is absorbed and hence the reflection of the incident radiation by the reflector 34c is reduced.

As discussed in relation to the embodiments above, the minimum reflection of out-of-band radiation from the reflector 34c will occur when the reflected waves from all the refractive index interfaces sum to a minimum at the radiation receiving surface 35. In the present embodiment there are four refractive index interfaces: a first interface 35 between the exterior of the reflector 34c and the MLM structure 36, a second interface 37 between the absorption layer 40a and the substrate 38; a third interface 37a between the absorption layer 40a and the MLM structure 36; and a fourth interface 39 between the substrate 38 and the exterior of the reflector 34a. In the present embodiment, only reflections from the first and second interfaces 35 and 37 are considered for the sake of simplicity. This is because it is thought that in the present embodiment, little reflection occurs from the third and fourth interfaces 37a and 39. It is thought that little reflection of the out-of-band radiation occurs from the third interface 37a due to the reflective indices of the alternating layers of the MLM structure 36 and that of the absorption layer 40a being similar. It is also thought that little reflection of the out-of-band radiation occurs at the fourth interface 39 because little out-of-band radiation is transmitted through the substrate to the interface 39. It will be appreciated that, in other embodiments of the invention, if the reflection from the third and fourth interfaces 37a and 39 is significant then waves reflected from these interfaces may be considered.

Again, as before, the reflected waves from the refractive index interfaces will sum to a minimum at the radiation receiving surface 35 at the radiation receiving surface 35 when the waves R1 and R2, once reflected from the reflector 34c, have the same amplitude and are in anti-phase. In this condition, there said to be total destructive interference between waves R1 and R2. In order to achieve this condition, several factors are taken into consideration: the refractive indices with respect to the out-of-band radiation of the alternating layers of the MLM structure 36, the substrate 38, the absorption layer 40a and the environment to the exterior of the reflector 34a (usually a vacuum); the absorbance with respect to the out-of-band radiation of the alternating layers of the MLM structure 36 and that of the absorption layer 40a (and depending on the embodiment, the absorbance of the substrate 38); the total thickness of the MLM structure 36; and the thickness of absorption layer 40a (and depending on the embodiment, the thickness of the substrate 38).

As previously discussed, altering the refractive indices will affect the amount of reflection at each interface and the optical path length of the out-of-band radiation through the MLM structure 34c.

As previously discussed, altering the total thickness of the MLM structure 36 will affect the optical path length of the radiation through the MLM structure 36 and also the amount of absorption of the out-of-band radiation by the MLM structure 36 as the out-of-band radiation travels through the MLM structure 36.

Altering the absorbance of the absorbing layer 40a will affect the level of absorption of a wave travelling through the absorbing layer 40a. For example increasing the absorbance of the absorbing layer 40a will increase the amount of the wave R2 travelling through the absorbing layer 40a which is absorbed by the absorption layer 40a. In this way, the amplitude of the incident wave R2 of out-of-band radiation once it has been reflected by the reflector 34c will be reduced if the absorbance of the absorbing layer 40a is increased.

Altering the thickness of the absorbing layer 40a will affect both the optical path length of wave R2 through the absorbing layer and also the amount of the wave R2 which is absorbed by the absorbing layer 40a. Increasing the thickness of the absorbing layer 40a will increase the optical path length of wave R2 through the absorbing layer 40a, hence altering the optical path difference (and hence phase difference) between waves R1 and R2 once they have been reflected by the reflector 34c. Also, by increasing the distance wave R2 has to travel through the absorbing layer 40a, the amplitude of wave R2 that is reflected by the reflector 40c will be decreased because the absorbing layer 40a, being an absorber of the out-of-band radiation, absorbs a greater proportion of wave R2 the further the wave R2 has to travel through it.

The absorbance and refractive index of any of the layers within the reflector 34c can be altered as described in relation to either of the embodiments above.

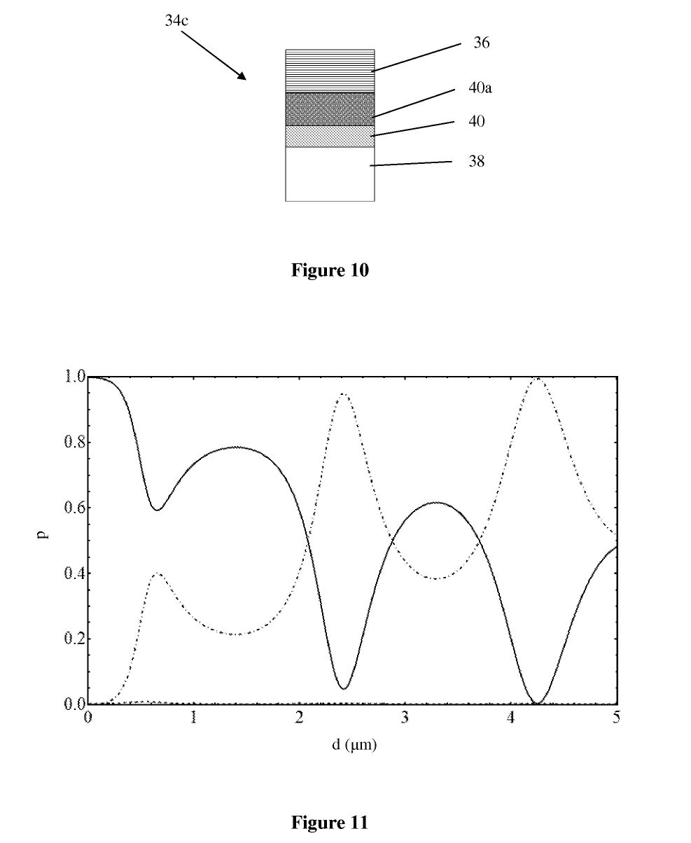

A reflector 34d according an embodiment of the present invention is shown in FIG. 10. The structure 34d comprises and MLM structure 36 comprising alternating layers 36 of DLC and n-type silicon (n-Si). The reflector 34d further comprises additional layers. The MLM structure is provided on the additional layers. The additional layers are an Si substrate 38, an absorption layer 40a adjacent the MLM structure 36, and a metal layer 40 adjacent the substrate 38. In this way, the reflector 34d forms a stack having the following order: MLM structure 36, absorption layer 40a, metal layer 40 and substrate 38. In the shown embodiment, the metal layer 40 is a 100 nm thick Mo layer and the absorption layer 40a is an n-Si layer. As for the preceding embodiment, any suitable material may be used for the absorption layer 40a provided it is capable of absorbing out-of-band radiation.

FIG. 11 shows the optical response of an MLM structure according to that shown in FIG. 10 as a function of the thickness of the absorption layer 40a (within the Figure, this is indicated by the axis labelled d). The DLC layers have a thickness of 2.8 nm and the n-Si layers have a thickness of 4.1 nm. There are 40 periods of the alternating layers 36. The concentration of charge carriers within the alternating layers 36 is approximately 10¹⁹ cm⁻³. The optical response is shown for radiation having a wavelength of 10.6 μm. Within FIG. 11, the solid line shows the proportion of incident radiation which is reflected, the dashed line shows the proportion of the radiation which is transmitted, and the dot-dashed line shows the proportion of radiation which is absorbed. Within the Figure, the axis labelled p is the proportion of incident radiation. It can be seen from the graph that there are two reflection minima: a first of about 5% for an absorption layer 40a thickness of about 2.4 μm and a second of less than 1% for an absorption layer 40a thickness of about 4.2 μm. It is thought that the minimum reflectance of this embodiment is less than that of the embodiments shown in either of FIGS. 5 and 7 because the effects of the reduced transmission due to the metal layer 40 and of the increased absorption due to the absorption layer 40a are combined.

In common with the previous embodiments, the reflection of the out-of-band radiation by the reflector 34d will be a minimum when the sum of all the reflected waves from all the refractive index interfaces is a minimum at the radiation receiving surface 35. Further explanation as to how this is achieved by altering parameters of the layers of the reflector 34d is omitted. This is because this embodiment can be likened to a combination of the second and third embodiments and as such comments relating to achieving a minimum sum of the reflected waves in relation to the second and third embodiments apply mutatis mutandis.

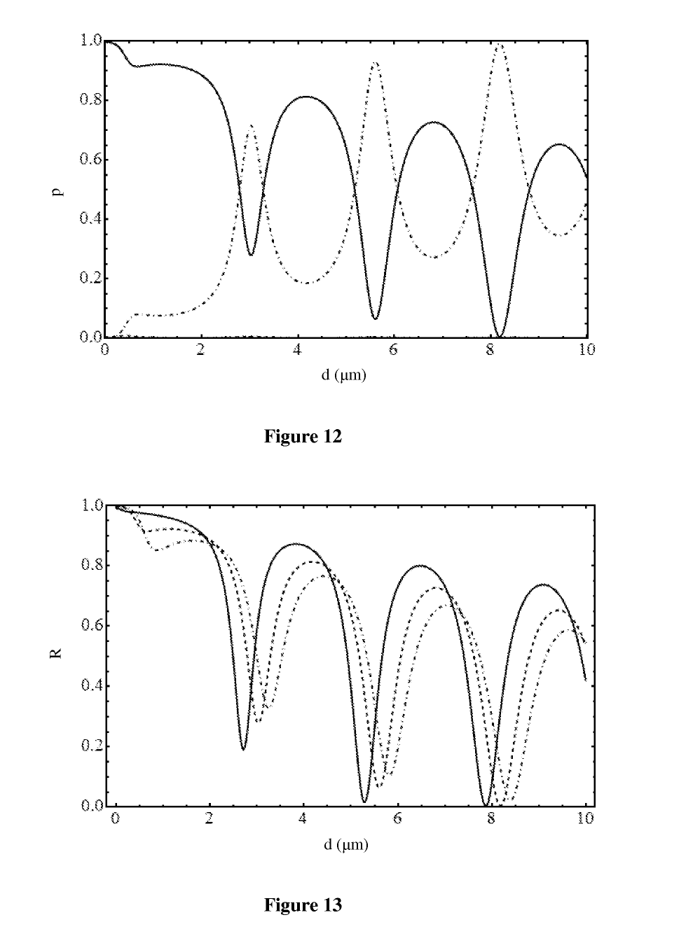

FIG. 12 shows the optical response of a further MLM structure, similar to that shown in FIG. 10, as a function of the thickness of the absorption layer 40a (within the Figure, this is indicated by the axis labelled d). The MLM structure differs from that described in relation to FIG. 10 in that the absorption layer 40a is an SiO₂ layer with a refractive index of 2.05 (+0.06 in the imaginary plane) and in that there are 60 periods of the alternating layers 36. The optical response is shown for radiation having a wavelength of 10.6 μm. Within FIG. 12, as before, the solid line shows the proportion of incident radiation which is reflected, the dashed line shows the proportion of the radiation which is transmitted, and the dot-dashed line shows the proportion of radiation which is absorbed. Within the Figure, the axis labelled p is the proportion of incident radiation. It can be seen from the graph that there are three reflection minima: a first of about 28% for an absorption layer 40a thickness of about 3 μm, a second of about 5% for an absorption layer 40a thickness of about 5.6 μm, and a third of less than 1% at about 8.2 μm.

The use of an absorption layer 40a which is an SiO₂ layer (as described in the embodiment above) as opposed to the use of an absorption layer 40a which is a doped silicon (e.g. n-Si) layer (as shown in the embodiment shown in FIG. 10) may be beneficial in some applications of the present invention. This is because at least some of the optical properties (including refractive index and absorption) of doped silicon are dependent on temperature. As previously discussed, the minimum reflection of out-of-band radiation from the reflector will occur when the reflected waves from all the refractive index interfaces sum to a minimum at the radiation receiving surface. The properties of some of the reflected waves will be dependent in part on the absorption and refractive index of the absorption layer 40a. It follows that a change in the absorption and/or refractive index of the absorption layer 40a may affect the amount of out-of-band radiation which is reflected by the reflector. Hence, a change in the temperature of a doped silicon absorption layer may cause the amount of out-of-band radiation which is reflected to increase, which may be undesirable. Because some of the out-of-band radiation absorbed by the reflector in use may be converted to heat, it is possible that the temperature of the reflector (and hence the absorption layer) will increase, thus affecting the absorption layer and hence the reflection of out-of-band-radiation as described. Other materials which may be used for the absorption layer, but which have optical properties which are substantially unaffected by temperature include WO₃, TiO₂, ZnO, SiC and other glassy materials. It will be appreciated that appropriate materials which are substantially unaffected by temperature may be used for the absorption layer 40a in any embodiment of the present invention which has an absorption layer.

As previously discussed, changing the number of periods within the alternating layers 36 will alter the optical path length of radiation within the alternating layers and may hence affect the reflectivity of the reflector of out-of-band radiation. FIG. 13 shows 3 plots of the optical response of three reflectors according to embodiments of the present invention as a function of the thickness of the absorption layer (indicated by the axis labelled d in the figure). The optical response is shown for radiation having a wavelength of 10.6 μm. The dashed line is the optical response of the reflector shown in FIG. 12. The solid line shows the optical response of a reflector similar to that of FIG. 12, except that the alternating layers of the reflector have 100 periods. The dot-dash line shows the optical response of a reflector similar to that of FIG. 12, except that the alternating layers of the reflector have 40 periods. Within the Figure, the axis labelled R is the proportion of incident radiation which is reflected by the reflector. It can be seen in FIG. 13, that increasing the number of periods in the alternating layers both reduces the reflectance of out-of-band radiation at each minimum and increases the maximum reflectance of out-of-band radiation between each minimum. Furthermore, increasing the number of periods within the alternating layers decreases the thickness of the absorbing layer corresponding to each reflectance minimum of the out-of-band radiation. This may be caused by the increased total thickness of the alternating layers absorbing a greater portion of some of the reflected waves and/or by the reflected waves having a greater optical path length within the alternating layers.

It will be appreciated that it is within the scope of the invention to provide a reflector having any number of additional layers (i.e. layers additional to the MLM structure). These one or more additional layers may be one or more absorbing or metal layers, providing that the sum of all the waves of out-of-band radiation which are reflected from the refractive index interfaces interfere in a destructive manner at the radiation receiving surface.

It will further be appreciated that a reflector according to embodiments of the present invention may comprise an additional layer which is adjacent the MLM structure, the additional layer being an absorbing layer which has the same refractive index for the out-of-band radiation as that of the bulk refractive index of the MLM structure for the out of band radiation. In this case there will be no reflection at the interface between the MLM structure and the absorbing layer adjacent it.

It will further be appreciated that although the reflectors according to embodiments of the present invention which have been described are generally flat, this need not be the case. A reflector according to embodiments of the present invention may be curved. For example, a collector optic of the source collector module according to embodiments of the present invention may have a curved profile. Other reflectors according to embodiments of the present invention which may be used within the illumination system or projection system may also be curved.

A reflector according to embodiments of the present invention may be operated in conjunction with incident radiation which has any incidence angle. It will be appreciated by those skilled in the art that a change in the incidence angle of the incident radiation will result in a change in the geometric length of the path the radiation (in particular the out-of-band radiation) follows through the reflector. For this reason, the thicknesses of the layers of the reflector may need to be changed depending on the incidence angle of the incident radiation. In the case of reflectors according to embodiments of the present invention which are curved, the radiation incident on different parts of the reflector may have a different incidence angles. In this case different parts of the reflector may have different layer thicknesses.

During the plasma creation process used to produce the beam of EUV radiation, the conversion of the fuel by the laser energy of laser beam 205 into plasma may be incomplete and hence fuel debris may be produced. The debris may come into contact with the collector CO and may form a layer of debris on the surface of the collector CO. The collector CO may be a reflector according to a previously described embodiment of the invention. The presence of a layer of debris on the surface of the collector CO may have a detrimental effect on the optical performance of the collector CO because it may increase the amount of out-of-band radiation which is reflected by the collector CO. It will be appreciated that the presence of a layer of debris on any reflector of the invention described above may have a similar detrimental effect on the optical performance.

Characteristics of the reflectors of the invention described above are configured so that out-of-band radiation which is reflected from the radiation receiving surface of the reflector interferes in a destructive manner (hereafter referred to as destructive interference) with out-of-band radiation which is reflected from within the reflector structure. These characteristics may be the absorbance (at the out-of-band wavelength), refractive index (at the out-of-band wavelength), and the thickness of the multi layer mirror structure and of one or more other layers. If these characteristics of the reflector are configured for the reflector in the absence of a debris layer, if a debris layer builds up on the reflector, then the amount of destructive interference between the reflected radiation waves of out-of-band radiation may be reduced (compared to the reflector without the debris layer). A reduction in the amount of destructive interference will increase the amount of out-of-band radiation which is reflected by the reflector.

As previously discussed, the reflectors described above have characteristics which are configured to achieve destructive interference of the out-of-band radiation. This may be achieved by controlling the optical path difference between waves reflected by different parts of the reflector and by controlling the relative amplitude of waves reflected by different parts of the reflector.

The surface of a layer of debris on the reflector may define the radiation receiving surface of the reflector. That is, the layer of debris may cause the surface of the reflector which defines the radiation receiving surface to change (compared to the radiation receiving surface of the reflector in the absence of the layer of debris). The change in the radiation receiving surface caused by the presence of a debris layer will result in a change in the optical path difference (and hence phase difference) at the radiation receiving surface between a wave of radiation which has been reflected by the radiation receiving surface and a wave of radiation that is reflected within the reflector. The change in the optical path difference (and hence phase difference) between the waves of reflected radiation may lead to an increase in the amount of out-of-band radiation reflected by the reflector.

A debris layer may further affect the optical path difference between reflected waves of out-of-band radiation (and hence the amount of destructive interference between the reflected waves of radiation) because the debris layer may have a refractive index (at the wavelength of the out-of-band radiation) which is different to that of the MLM structures and/or any other layer(s) within the reflector.

The reflectivity of the radiation receiving surface of out-of-band radiation of a reflector having a debris layer may be different to the reflectivity of the radiation receiving surface of a reflector which does not have a debris layer. For this reason, the amount of out-of-band radiation which is reflected by the radiation receiving surface may be different for a reflector having a debris layer compared to a reflector without a debris layer. Reduced levels of destructive interference between the reflected radiation waves of out-of-band radiation of a reflector having a debris layer (and characteristics which have been configured in the absence of a debris layer) may result from a different amount of out-of-band radiation being reflected by the radiation receiving surface of the reflector having the debris layer (compared to that of the same reflector without a debris layer).

A debris layer may additionally affect the amount of destructive interference between the waves of radiation reflected by the reflector due to the fact that the debris layer may absorb some of the out-of-band radiation. If the debris layer absorbs some of the out-of-band radiation then the amount of radiation which is reflected from within a reflector with a debris layer will be less than the amount of radiation which would be reflected by the same reflector without a debris layer.

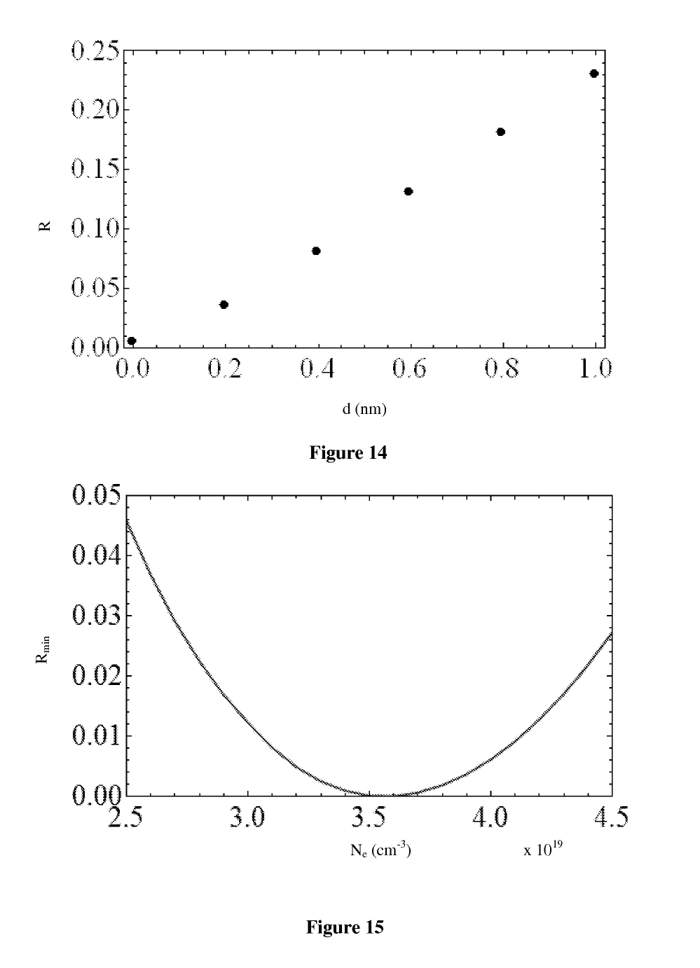

FIG. 14 shows a graph of the reflectivity (R) of out-of-band radiation of a reflector according to an embodiment which is not optimized for the presence of a debris layer. The reflector comprises a doped silicon (n-Si) substrate, upon which there is a 700 nm thick anti-reflection layer of ThF₄. A multi layer mirror structure comprising 40 periods of a 4.1 nm thick Si layer and a 2.8 nm thick DLC layer is disposed upon the ThF₄ layer. The reflector has been coated with a debris layer. The debris layer is a tin layer. The graph shows the reflectivity of the reflector of out-of-band radiation having a wavelength of 10.6 μm as a function of thickness (d) of the debris layer. It can be seen that the amount of out-of-band radiation reflected by the reflector increases with increasing thickness of the debris layer. Once the thickness of the debris layer has increased to about 1 nm the reflectivity of the reflector of out-of-band radiation is about 25%. This high level of reflectivity of out-of-band radiation may in some cases be detrimental to the performance of the lithographic apparatus.

In some embodiments it may be beneficial to configure the reflector such that, when the reflector has a debris layer, out-of-band radiation which is reflected from the radiation receiving surface of the reflector interferes in a destructive manner with out-of-band radiation which is reflected from within the reflector structure. In an equivalent manner to reflector embodiments described above, configuring the reflector such that out-of-band radiation interferes in a destructive manner may be achieved by configuring the absorbance and refractive index of the multi layer mirror structure and the one or more additional layers of the reflector with respect to out-of-band radiation, and by configuring the thickness of the multi layer mirror structure and the one or more additional layers of the reflector.

An example of how a reflector may be configured such that, when the reflector has a debris layer, destructive interference of the out-of-band radiation occurs, is configuring the number of periods within the multi layer mirror (MLM) structure and thereby configuring the thickness of the MLM structure. Another example is by using different materials (with different optical properties) to form the layers of the MLM structure or one or more other layers of the reflector. One way of forming layers of the reflector from different materials is to dope the materials of the reflector.

During the operation of the lithographic apparatus of which a reflector according to an embodiment of the invention forms part, the thickness of the debris layer may increase over time.

Changing the thickness of a debris layer on a reflector changes the amount of out-of band radiation which is absorbed by the debris layer and changes the optical path difference between reflected wave of out-of-band radiation. It follows that certain reflectors according to embodiments of the present invention may be configured such that they are optimized for a particular thickness of debris layer (i.e. such that destructive interference between waves of reflected out-of-band radiation is a maximum at a certain thickness of debris layer). In some embodiments of the reflector, this may be disadvantageous because when the debris layer does not have the thickness that the reflector has been configured to be optimized for, then the destructive interference caused by the reflector between waves of out-of-band radiation will not be at a maximum (and hence the amount of out-of-band radiation reflected by the reflector will not be at a minimum).

Some reflectors according to embodiments of the invention may be configured such that their characteristics can be changed after the reflector has been constructed. For example, it may be possible to change characteristics of the reflector whist the reflector is in situ within a lithographic apparatus. The characteristics of the reflector may be changed in response to a change in thickness (such as an increase in thickness) of the debris layer. If the thickness of the debris layer on the reflector is changing, the characteristics of the reflector may changed so that the reflector is configured such that it is optimized (i.e. has a maximum in destructive interference of reflected waves of out-of-band radiation) for the thickness of the debris layer at a given moment in time.

An example of a characteristic of a reflector according to an embodiment of the present invention which may be changed after the construction of the reflector is the concentration of charge carriers within the MLM structure. It will be appreciated that the concentration of charge carriers of one or more of the other layers of a reflector may also be changed. FIG. 15 shows a graph of the minimum reflectivity of out-of-band radiation of a reflector according to an embodiment the invention as a function of charge carrier concentration. In this case, the reflector does not have a debris layer. It can be seen that as the charge carrier concentration increases the minimum reflectivity of out-of-band radiation of the reflector passes through a minimum. In this case a minimum reflectivity of out-of-band (10.6 μm) radiation of less than about 0.1% occurs when the free carriers concentration within the MLM structure is about 3.6×10¹⁹ cm⁻³.

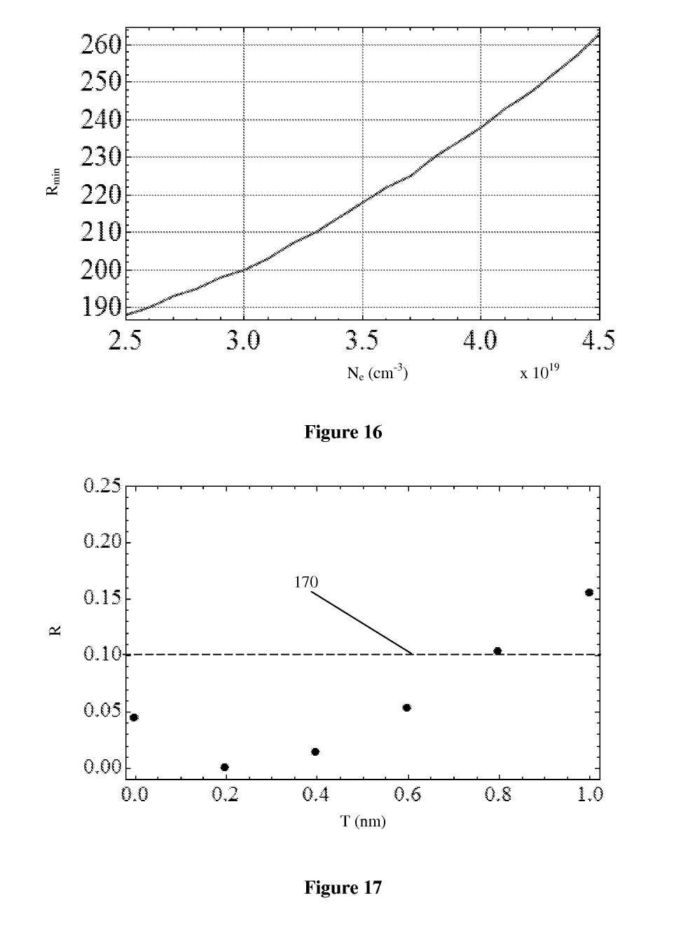

One way of changing the concentration of charge carriers within the MLM structure is by changing the number of periods in the MLM structure. FIG. 16 shows a graph which shows the relationship between the number of periods in an MLM structure of a reflector and the concentration of charge carriers. The reflector which has the relationship shown in the graph of FIG. 16 is the same as that described in relation to FIG. 15. Referring to FIG. 15, it could be seen that the optimum concentration of charge carriers within the MLM structure (such that the reflector has the minimum reflectivity of out-of-band radiation) was about 3.6×10¹⁹ cm⁻³. Referring now to FIG. 16, it can be seen that a charge carrier concentration of about 3.6×10¹⁹ cm⁻³ occurs when the number of periods of the MLM structure is about 220. It will be appreciated that changing the concentration of charge carriers within the MLM structure by changing the number of periods in the MLM structure is not possible after the construction of the reflector.

An example of a way in which the concentration of charge carriers can be changed after the construction of the reflector (for example when the reflector is in situ within a lithographic apparatus) is by changing the temperature of the reflector. This may be achieved by using known heating/cooling systems. Such systems may be water-based. Increasing the temperature of the reflector will increase the concentration of charge carriers within the reflector (for example in the MLM structure). This is because an increase in temperature causes electrons within the reflector (for example in the MLM structure) to be liberated. By controlling the temperature of the reflector, the charge carrier concentration can be actively changed so that the reflector is optimized for a particular thickness of debris layer. In this context, the term ‘actively changed’ may be considered to comprise controlling the charge carrier concentration to some extent. This may contrast for example with passive changes of the charge carrier concentration, i.e. changes of the charge carrier concentration in a manner that is not controlled.

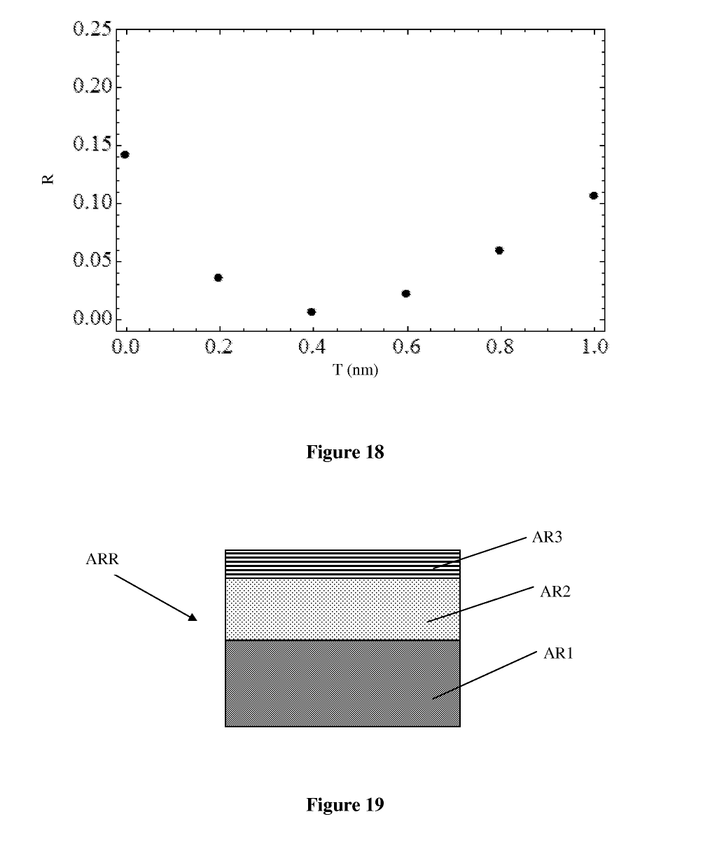

It will be appreciated that in some embodiments of the invention it may be advantageous to change the characteristics of the reflector in response to a change in thickness (such as an increase in thickness) of the debris layer. In other embodiments, the characteristics of the reflector may be chosen such that the reflector is optimized (i.e. has a minimum reflectance of out-of-band radiation) for a particular thickness of debris layer. FIGS. 17 and 18 show two graphs, each showing the performance of a reflector according to an embodiment of the invention. Both show the reflectivity (R) of out-of-band radiation (10.6 μm) of a reflector as a function of the thickness (T) of the debris layer which is formed on each of them. The reflectors, the performance of which are described in each of the Figures, have the same general structure as that shown in FIG. 6. Each reflector has a silicon substrate, upon which there is a 100 nm thickness layer of molybdenum upon which is the MLM structure. The MLM structure comprises alternating DLC layers and n-Si layers which have thicknesses of 2.8 nm and 4.1 nm respectively. In each of the FIGS. 17 and 18, the debris layer is tin. In FIG. 17 the characteristics (e.g. number of periods and temperature) of the MLM structure of the reflector have been chosen such that the MLM structure has a charge carrier concentration of 2.5×10¹⁹ cm⁻³. In FIG. 18 the characteristics of the MLM structure of the reflector have been chosen such that the MLM structure has a charge carrier concentration of 2.0×10¹⁹ cm⁻³.

It can be seen that the reflector of FIG. 17 (the MLM structure of which has a charge carrier concentration of 2.5×10¹⁹ cm⁻³) has a minimum reflectivity of out of band radiation of less than about 1% at a debris layer thickness of about 2 nm. The reflector of FIG. 18 (the MLM structure of which has a charge carrier concentration of 2.0×10¹⁹ cm⁻³) has a minimum reflectivity of out of band radiation of less than about 1% at a debris layer thickness of about 4 nm. It follows that the reflector of FIG. 17 is optimized for a tin debris layer with a thickness of 2 nm, whereas the reflector of FIG. 18 is optimized for a tin debris layer with a thickness of 4 nm.

It can also be seen that, for both the reflectors of FIGS. 17 and 18, the reflectivity of the reflectors of out-of-band radiation (as a function of increasing thickness of debris layer) decreases to a minimum reflectivity at a particular debris layer thickness and then increases. This property of the reflectors may, in some embodiments, be used to create reflectors which have a greater working lifetime. It will be appreciated that the reflector may be used in an environment (for example, as a collector within the source module of a lithographic apparatus) where the thickness of the debris layer increases over time. Using FIG. 17 as an example, a lithographic apparatus incorporating a reflector of FIG. 17 may be capable of operating effectively while the amount of out-of-band radiation reflected by the reflector is less than 10%. The lithographic apparatus will thus be capable of operating effectively providing that the reflectivity of out-of-band radiation is below line 170 on the graph. The graph shows that if the reflector initially does not have a debris layer then the lithographic apparatus may be capable of operating effectively. It will continue to be capable of operating effectively while the thickness of the debris layer grows, until the thickness of the debris layer is just less than 0.8 nm. Beyond this thickness of debris layer the lithographic apparatus will not operate effectively. This may provide an advantage over a reflector which is optimized for, for example, no debris layer. If a reflector was optimized for no debris layer, and had the same reflectivity change as a function of debris layer thickness, then the lithographic apparatus would not operate effectively when the thickness of the debris layer reached around 0.6 nm. The reflector would therefore need to be cleaned more frequently, thereby increasing the downtime of the lithographic apparatus.

The reflector may be configured such that when no debris is present on the reflector, the reflectivity of the reflector for out of band radiation is below a predetermined threshold but is not at a minimum. The predetermined threshold of the reflectivity may be a reflectivity below which the lithographic apparatus may operate effectively, and above which the lithographic apparatus would not operate effectively. The reflectivity of the reflector will pass through a minimum as the thickness of the debris layer on the reflector increases.

The optimization of the reflector for a particular thickness of debris layer (compared to its optimisation for the absence of a debris layer) can be likened to shifting the response of the reflector (as shown in FIG. 17) to the right (i.e. in the direction of increasing debris layer thickness). Shifting the response of the reflector to the right means that (for debris layer thicknesses greater than that at which the minimum reflectivity of out-of-band radiation occurs), for a given debris layer thickness, the reflector will have a lower reflectivity of out-of-band radiation compared to a reflector which is optimized for the absence of a debris layer. In other words, for a given reflectivity of out-of-band radiation, the thickness of the debris layer of the reflector which has been optimized for a particular thickness of debris layer will be greater than that of the debris layer of the reflector which has been optimized for the absence of a debris layer. Because the debris layer thickness increases with time in certain situations (e.g. when the reflector is a collector within a lithographic apparatus) reducing the reflectivity of the reflector of out-of-band radiation for a given thickness of debris layer means that the reflector can be used for a greater period of time. For this reason, in such a situation, a reflector which has been optimized for a particular thickness of debris layer may be used for a greater period of time than a reflector which has been optimized for the absence of a debris layer. Increasing the period of time for which a reflector can be used (e.g. within a lithographic apparatus) may be advantageous as it will reduce the frequency with which the reflector has to be replaced or cleaned and will hence reduce the operating costs of any apparatus of which the reflector forms part.

It will be appreciated that the example given above in relation to FIG. 17 in which the lithographic apparatus is not capable of operating effectively when the reflectivity of the reflector of out-of-band radiation exceeds 10% is merely an example. The lithographic apparatus (or other apparatus of which the reflector forms part) may not be capable of operating effectively when the reflectivity of the reflector of out-of-band radiation is above any appropriate given level.

It will be appreciated that when the reflector is optimized for a particular thickness of debris layer so as to extend the working lifetime of the reflector, the particular thickness will be less than the thickness of the debris layer that will be received by the reflector in the working life time of the reflector. In some embodiments, the particular thickness of debris layer for which the reflector is optimized may be less than half the thickness of the debris layer that will be received by the reflector in the working life of the reflector. The characteristics of the reflector may be chosen such that the reflector is optimized for a particular thickness of debris layer and such that the reflectivity of the reflector of out-of-band radiation is below a threshold in the absence of a debris layer on the reflector. The threshold may be the reflectivity above which the apparatus of which the reflector forms part is not capable of operating effectively.

A reflector which is optimized for the presence of a debris layer, may be optimized for any appropriate thickness of debris layer. For example, the reflector may be optimized for a debris layer which is less than about 5 nm thick, preferably less than about 1 nm thick, more preferably less than about 0.5 nm thick and further preferably about 0.2 nm thick. In some embodiments, the reflector may be optimized for a debris layer thickness which is approximately the thickness of a mono-layer of debris material. The mono-layer of debris material may be the minimum thickness the debris material can be reduced to when cleaning the reflector using a gas (having had debris deposited on it previously). In the case of tin, the mono-layer may have a thickness of about 0.2 nm.

The reflector may be configured such that when a mono-layer of debris is present on the reflector, the reflectivity of the reflector for out of band radiation is below a predetermined threshold but is not at a minimum. The predetermined threshold of the reflectivity may be a reflectivity below which the lithographic apparatus may operate effectively, and above which the lithographic apparatus would not operate effectively. The reflectivity of the reflector will pass through a minimum as the thickness of the debris layer on the reflector increases.

Reflectors which comprise an MLM structure and an anti-reflection layer (e.g. an anti-reflection coating) may also be optimized for the presence of a particular thickness of debris layer on the MLM structure. FIG. 19 shows a reflector ARR comprising a substrate AR1 upon which there is an anti-reflection (AR) layer AR2. A MLM structure AR3 is deposited upon the AR layer. In the same manner as the previously described embodiments, the MLM structure AR3 is configured to reflect in-band radiation. In this embodiment, as before, the in-band radiation is EUV radiation (for example with a wavelength of between 13 and 14 nm). The MLM structure AR3, as before, has alternating layers of DLC and Si which have thicknesses of 2.8 nm and 4.1 nm respectively. The AR layer AR2 is configured such that it promotes the passage of out-of-band radiation from the MLM structure AR3 and into the substrate AR1. Examples of materials which may be used for the AR layer include ThF₄, YF₃ and MgF₂. The substrate AR1 is constructed from a material which is absorbing of the out-of-band radiation. Examples of materials which may be used to form the substrate include doped Si and doped Ge.

The reflector ARR minimizes reflection of out-of-band radiation because the AR layer AR2 is configured to promote the passage of out-of-band radiation into the substrate AR1. The substrate AR1, being formed of material which is absorbent of out-of-band radiation, absorbs the out-of-band radiation which has passed from the MLM structure AR 3 through the AR layer AR2 and into the substrate AR1. Because the out-of-band radiation is absorbed by the substrate AR1 the amount of out-of-band radiation which is reflected by the reflector ARR is reduced. The reflector ARR works in a different manner to the other reflectors according to embodiments of the present invention which are described above. This is because the other reflectors described above are configured to cause destructive interference (at the radiation receiving surface of the reflector) of the waves of out-of-band radiation which are reflected by the reflector.

Due to the fact that the reflector ARR minimizes reflection of out-of-band radiation by promoting the passage of out-of-band radiation from the MLM structure into the substrate, as opposed to by causing destructive interference of the out-of-band radiation, the charge carrier concentration (and hence absorbance of out-of-band radiation and refractive index) of the MLM structure is less important. Instead, the performance of a reflector comprising an AR layer can be controlled by configuring the thickness and/or material of the AR layer AR2.

The presence of a debris layer on the MLM structure AR3 of the reflector ARR may affect the amount of out-of-band radiation which is reflected by the reflector ARR because the debris layer may have a high refractive index and a high electric permittivity.

The reflector ARR can be optimized (i.e. such that the amount of reflected out-of-band radiation is minimized) for the presence of a debris layer (not shown) on the MLM structure AR3 by configuring the thickness and material of the AR layer AR2. The thickness and/or material of the AR layer AR2 will be different for a reflector optimized for a particular thickness of debris layer compared to a reflector which is optimized for the absence of a debris layer. For example, if the debris layer is a tin layer of the order of 0.1-1 nm thick, the thickness of the AR layer (AR2) may be 950 nm compared to 700 nm for a reflector which is optimized for the absence of a debris layer.

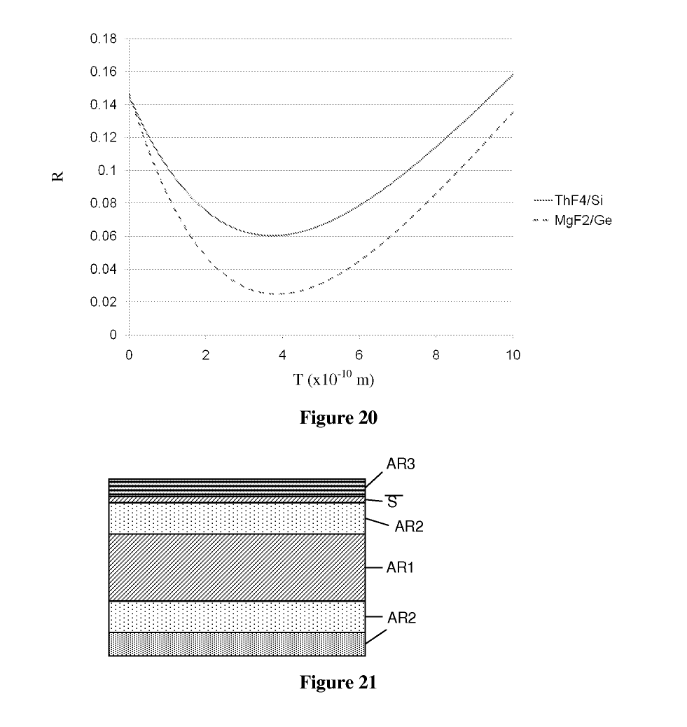

FIG. 20 shows a graph of the reflectance (R) of out-of-band radiation (10.6 μm) of two reflectors comprising AR layers, as a function of the thickness (T) of the debris layer. Each reflector has a structure which has the same form as that shown in FIG. 19. Referring to FIG. 19, both reflectors have an MLM structure AR3 which has alternating layers of DLC and Si which have thicknesses of 2.8 nm and 4.1 nm respectively. The MLM structures of both have 40 periods. The reflector of the solid line has a doped silicon (n-Si) substrate and a ThF₄ AR layer which has a thickness of 950 nm. The reflector of the dashed line has a doped germanium (n-Ge) substrate and an MgF₂ substrate which has a thickness of 950 nm. In both cases the MLM structure AR3 is provided on an AR layer AR2, which in turn is provided on a substrate AR1. The debris layer is a tin layer.

It can be seen that the reflector of the dashed line has a minimum reflectance of out-of-band radiation of about 2.5% at a debris layer thickness of about 3.8×10⁻¹⁰ m, whereas the reflector of the solid line has a minimum reflectance of out-of-band radiation of about 6% at a debris layer thickness of about 3.6×10⁻¹⁰ m. It follows that the reflector of the dashed line and the reflector of the solid are optimized for tin debris layers of thicknesses of about 3.8×10⁻¹⁰ m and 3.6×10⁻¹⁰ m respectively.

It will be appreciated that any appropriate materials may be used to form the MLM structure, AR layer and substrate. The layers may have any appropriate thickness. The in-band and out-of-band radiation may be any type of radiation. The debris layer may be formed from any material.

FIG. 21 discloses a further reflector ARR. This reflector ARR also minimizes out-of-band radiation, because the AR layer AR2 is configured to promote the passage of out-of-band radiation into the substrate AR1. The substrate AR1 may be configured to transmit more than 50% of incoming infrared radiation. The backside of the substrate AR1 (the backside being faced away from the MLM structure AR3) may be provided with another AR layer AR2. In FIG. 21, the layer AR2 is a ThF₄ layer having an additional ZnSe layer on its backside. Unwanted infrared radiation is transmitted through the reflector ARR and may be absorbed elsewhere. Also a smoothing layer S is provided between the MLM structure AR3 and the substrate AR1.

The MLM structure AR3 in FIG. 21 includes alternating layers of diamond-like carbon and Si. The diamond-like carbon layers may have a thickness of 4.1 nm and the diamond-like carbon layers may have a thickness of about 2.8 nm. The diamond-like carbon and/or the Si layers are doped, preferably with an impurity concentration of between 5×10¹⁸ cm⁻³ and 5×10¹⁹ cm⁻³, preferably between 8×10¹⁸ cm⁻³ and 2×10¹⁹ cm⁻³. Typically, about 1×10¹⁹ cm⁻³ is a suitable impurity concentration. The smoothing layer may be a Si layer and have a thickness of about 20 nm. The substrate AR1 may be formed by Si, SiO₂ or another material. The AR layers AR2 may have a thickness between about 650 nm and about 690 nm, for instance 660 nm or 684 nm.

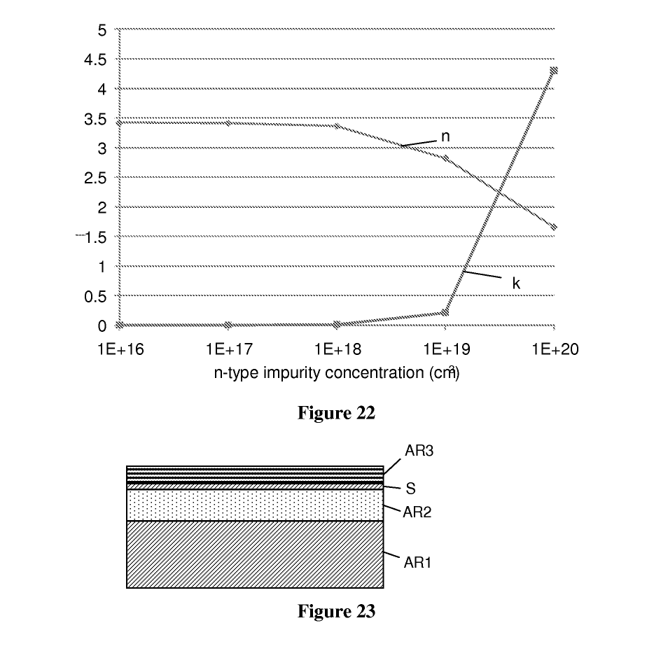

FIG. 22 depicts a graph in which the refractive index of Si as a function of an impurity concentration of Si, in this example an n-type dopant concentration, is shown. It can be seen in FIG. 22 that at an impurity of about 1×10¹⁹ cm⁻³ a real part n of the refractive index has a value of 2.82 and an imaginary part k of the refractive index has a value of 0.21. By significantly reducing the real part of the refractive index, i.e. from 3.42 at lower concentrations to 2.82 at a concentration of 1×10¹⁹ cm⁻³, the anti-reflective properties of Si improve, allowing for a higher number of layers in the MLM structure.

FIG. 23 discloses a yet further reflector ARR. A difference with the reflector of FIG. 21 is that the substrate AR1 is configured to absorb the infrared radiation. The AR layer AR2 may be 640 nm thick. Again, the MLM structure AR3 in FIG. 23 includes alternating layers of diamond-like carbon and Si. The diamond-like carbon layers may have a thickness of 4.1 nm and the diamond-like carbon layers may have a thickness of about 2.8 nm. The diamond-like carbon and/or the Si layers are doped, preferably with an impurity concentration of between 5×10¹⁸ cm^{-3 and} 5×10¹⁹ cm⁻³, preferably between 8×10¹⁸ cm⁻³ and 2×10¹⁹ cm⁻³. Typically, about 1×10¹⁹ cm⁻³ is a suitable impurity concentration. The smoothing layer S may be a Si layer and have a thickness of about 20 nm. The substrate AR1 may be formed by Si doped with an impurity of 2×10¹⁸ cm⁻³. In this example, the impurity concentrations are n-type dopant concentration. Of course, p-type dopant concentrations can alternatively be applied.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “substrate” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The term “lens”, where the context allows, may refer to any one or combination of various types of optical components, including refractive, reflective, magnetic, electromagnetic and electrostatic optical components.

Within the description EUV radiation has been used as an example of useful, in-band radiation and IR radiation has been used as an example of non-useful, out-of-band radiation. It will be appreciated that these are merely examples and that, depending on the application of the lithographic apparatus, the useful, in-band radiation and non-useful, out-of-band radiation may be any wavelength of radiation. It follows that it would be clear to the person skilled in the art that, depending on the wavelength of the in-band and out-of-band radiation, the characteristics of the reflector will may be optimized for those wavelengths. The characteristics of the reflector may be optimized such that the reflector has a relatively high reflectance for the in-band radiation and a relatively low reflectance for the out-of-band radiation. Examples of the characteristics of the reflector which may be optimized include: the material of the substrate, the material and/or thickness of any absorption layer, the material and/or thickness of any metal layer, the material and/or thickness of the individual layers that make up the alternating layers of the MLM structure, and the number of periods of the alternating layers of the MLM structure.

It will also be appreciated that a reflector according to embodiments of the present invention may be used as a reflector in any appropriate type of lithographic apparatus.

The descriptions above are intended to be illustrative, not limiting. Thus it will be apparent to one skilled in the art that modifications may be made to the invention as described without departing from the scope of the claims set out below.

1. A reflector comprising a multi layer mirror structure configured to reflect radiation at a first wavelength, and one or more additional layers, the absorbance and refractive index at a second wavelength of the multi layer mirror structure and the one or more additional layers, and the thickness of the multi layer mirror structure and the one or more additional layers, being configured such that radiation of the second wavelength which is reflected from a surface of the reflector interferes in a destructive manner with radiation of the second wavelength which is reflected from within the reflector.

2. The reflector of claim 1, wherein the one or more additional layers comprises a substrate, wherein the one or more additional layers further comprise a metal layer located intermediate the substrate and the multi layer mirror structure and wherein the metal layer has a thickness which is greater than the skin depth of the metal for radiation of the second wavelength.

3. The reflector of claim 1, wherein the one or more additional layers comprises a substrate, wherein the one or more additional layers further comprises an absorption layer located intermediate the substrate and the multi layer mirror structure, the absorption layer being configured to absorb radiation of the second wavelength.

4. The reflector of claim 3, wherein the one or more additional layers further comprise a metal layer located intermediate the substrate and the multi layer mirror structure, wherein the absorption layer is intermediate the metal layer and the multi layer mirror structure.

5. The reflector of claim 1, wherein the one or more additional layers comprises only a substrate, and the substrate has a refractive index at the second wavelength which is different to a refractive index of the multi layer mirror structure at the second wavelength.

6. The reflector of claim 1, wherein the multi layer mirror structure comprises alternating layers of n-type silicon and diamond-like carbon.

7. A reflector comprising a multi layer mirror structure configured to reflect radiation at a first wavelength, and one or more additional layers,
wherein the absorbance and refractive index at a second wavelength of the multi layer mirror structure and the one or more additional layers, and the thickness of the multi layer mirror structure and the one or more additional layers, are configured such that radiation of the second wavelength which is reflected from a surface of the reflector interferes in a destructive manner with radiation of the second wavelength which is reflected from within the reflector, when a layer of debris material is received by the multi layer mirror structure, the layer of debris material defining the surface of the reflector.

8. The reflector of claim 7, wherein in use the thickness of the layer of debris material will increase over time, and wherein the absorbance and refractive index at a second wavelength of the multi layer mirror structure and the one or more additional layers, and the thickness of the multi layer mirror structure and the one or more additional layers, are configured such that, when a particular thickness of debris material layer is received by the multi layer mirror structure, radiation of the second wavelength which is reflected from the surface of the reflector interferes in a destructive manner with radiation of the second wavelength which is reflected from within the reflector.

9. The reflector of claim 7, wherein the reflector is configured such that the reflectivity of radiation of the second wavelength of the reflector passes through a minimum reflectivity as the thickness of the debris layer increases, the minimum reflectivity occurring when the debris layer has a particular thickness.

10. The reflector of claim 7, wherein in use the thickness of the layer of debris material will increase over time, and wherein the reflector is configured such that at least one characteristic of the reflector including the absorbance and refractive index at a second wavelength of the multi layer mirror structure, the absorbance and refractive index at a second wavelength of the one or more additional layers, the thickness of the multi layer mirror structure, and the thickness of one or more additional layers, may be actively changed over time as a function of the thickness of debris layer, such that radiation of the second wavelength which is reflected from the surface of the reflector interferes in a destructive manner with radiation of the second wavelength which is reflected from within the reflector.

11. The reflector of claim 10, wherein the reflector is configured such that the temperature of the reflector may be actively changed to actively change the at least one characteristic of the reflector.

12. The reflector of claim 10, wherein the change in the at least one characteristic of the reflector arises from a change in the charge carrier concentration within at least one of the multi layer mirror structure and the one or more additional layers.

13. A reflector comprising a multi layer mirror structure configured to reflect radiation at a first wavelength, a substrate configured to absorb radiation at a second wavelength, and an anti reflection layer between the multi layer mirror structure and the substrate, the anti reflection layer being configured to promote the passage of radiation at the second wavelength from the multi layer mirror structure to the substrate,
wherein the absorbance and refractive index at a second wavelength of the multi layer mirror structure and the anti reflection layer, and the thickness of the multi layer mirror structure and the anti reflection layer, are configured such that radiation of the second wavelength which is reflected from a surface of the reflector is less than that which is reflected from the multilayer mirror structure of the reflector without a layer of debris material, when a layer of debris material is received by the multi layer mirror structure, the layer of debris material defining the surface of the reflector.

14. A lithographic apparatus having a source collector module configured to collect radiation, an illumination system configured to condition the radiation, and a projection system configured to project a radiation beam formed from the radiation onto a substrate, wherein the source collector module, the illumination system, and/or the projection system comprises a reflector comprising a multi layer mirror structure configured to reflect radiation at a first wavelength, and one or more additional layers, the absorbance and refractive index at a second wavelength of the multi layer mirror structure and the one or more additional layers, and the thickness of the multi layer mirror structure and the one or more additional layers, being configured such that radiation of the second wavelength which is reflected from a surface of the reflector interferes in a destructive manner with radiation of the second wavelength which is reflected from within the reflector.

15. A spectral purity filter configured to reflect extreme ultraviolet radiation, the spectral purity filter comprising:
a substrate;
an anti-reflection coating on a top surface of the substrate, the anti-reflection coating being configured to transmit infrared radiation; and
a multi-layer stack configured to reflect extreme ultraviolet radiation and to substantially transmit infrared radiation, the multi-layer stack comprising alternating layers of Si and diamond-like carbon, wherein the Si is doped So and/or the diamond-like carbon is doped diamond-like carbon.

16. A lithographic apparatus comprising:
a source collector module configured to collect radiation;
an illumination system configured to condition the radiation; and
a projection system configured to project a radiation beam formed from the radiation onto a substrate,
wherein the source collector module, the illumination system, and/or the projection system comprises
a reflector comprising a multi layer mirror structure configured to reflect radiation at a first wavelength, a substrate configured to absorb radiation at a second wavelength, and an anti reflection layer between the multi layer mirror structure and the substrate, the anti reflection layer being configured to promote the passage of radiation at the second wavelength from the multi layer mirror structure to the substrate,
wherein the absorbance and refractive index at a second wavelength of the multi layer mirror structure and the anti reflection layer, and the thickness of the multi layer mirror structure and the anti reflection layer, are configured such that radiation of the second wavelength which is reflected from a surface of the reflector is less than that which is reflected from the multilayer mirror structure of the reflector without a layer of debris material, when a layer of debris material is received by the multi layer mirror structure, the layer of debris material defining the surface of the reflector.
